(19) United States
(12) Patent Application Publication
(10) Pub. No.: US 2021/0224857 A1
(43) Pub. Date: Jul. 22, 2021

(54) GENERATING AND PROVIDING DIMENSION-BASED LOOKALIKE SEGMENTS FOR A TARGET SEGMENT

(71) Applicant: Adobe Inc., San Jose, CA (US)

(72) Inventors: Ritwik Sinha, Cupertino, CA (US); William George, Pleasant Grove, UT (US); Said Kobeissi, Lovettsville, VA (US); Raymond Wong, Jersey City, NJ (US); Prithvi Bhutani, Seattle, WA (US); Ilya Reznik, Millcreek, UT (US); Fan Du, Santa Clara, CA (US); David Arbour, San Jose, CA (US); Chris Challis, Alpine, UT (US); Atanu Sinha, Bangalore (IN); Anup Rao, San Jose, CA (US)

(21) Appl. No.: 16/746,531

(22) Filed: Jan. 17, 2020

(51) Int. Cl. G06Q 30/02; G06F 16/22; G06F 3/0482

(52) U.S. Cl. CPC G06Q 30/0269; G06F 16/221; G06F 16/2264; G06F 3/0482; G06Q 30/0255; G06Q 30/0261; G06F 16/2246

(57) ABSTRACT

The present disclosure describes systems, methods, and non-transitory computer readable media for generating lookalike segments corresponding to a target segment using decision trees and providing a graphical user interface comprising nodes representing such lookalike segments. Upon receiving an indication of a target segment, for instance, the disclosed systems can generate a lookalike segment from a set of users by partitioning the set of users according to one or more dimensions based on probabilities of subsets of users matching the target segment. By partitioning subsets of users within a node tree, the disclosed systems can identify different subsets of users partitioned according to different dimensions from the set of users. The disclosed systems can further provide a node tree interface comprising a node for the set of users and nodes for subsets of users within one or more lookalike segments.

### BACKGROUND

In recent years, software engineers have developed digital-content-campaign systems that can enable marketing professionals to build complex and customizable target segments by selecting various dimensions on which to define the segments. For example, some conventional digital-content-campaign systems can generate target segments based on scoring users for propensities to achieve a target goal. Indeed, many conventional digital-content-campaign systems can generate scores for users based on monitoring user behavior over time to identify users that fit a target segment.

Despite these advances, conventional digital-content-campaign systems suffer from a number of technical disadvantages, especially in terms of efficiency and flexibility. Because some digital-content-campaign systems perform various tasks in isolation from other computing systems, conventional systems commonly use extensive amounts of computer resources to generate segments of users or other entities that fit a target segment. For example, conventional systems use extensive amounts of computer resources to identify segments of users similar to a target segment, where such a similar segment shares characteristics with (or accomplishes a goal of) users of a target segment. In some cases, conventional systems consume excessive memory, processing power, and computing time to generate such segments similar to a target segment.

In some environments, for instance, conventional systems use a segmented architecture requiring a complex, expensive procedure over days or weeks to generate segments similar to a target segment. To generate such similar segments, conventional systems initially transfer user data from an analytics database to a computing environment, consuming between hours and days for such transfer. After transferring the user data, conventional systems use the computing environment to analyze the data to generate features and build a supervised learning model to score users, consuming between days and weeks to process. Upon identifying a segment similar to a target segment based on user scores, such conventional systems transfer the similar segment back to the analytics database, again consuming additional computing time and power. To complete the entire process of generating a reportable, actionable segment similar to a target segment, a conventional system can take days to weeks, require an inordinate amount of processing power, and enlist a data scientist's supervision.

In addition to the inefficiencies of generating such similar segments—and in part because of such inefficiencies—some conventional digital-content-campaign systems provide inefficient user interfaces. Because some conventional systems require separate architectures to generate a segment similar to a target segment, such conventional systems often present user interfaces that require excessive numbers of user interactions to navigate between various interfaces or layers of interfaces. Some conventional digital-content-campaign systems use separate user interfaces to access different information or functionality involved in generating similar segments. For instance, such conventional and isolated user interfaces may include a separate user interface for transferring data and a separate interface for building a supervised learning model using a target segment as a label for the model.

In addition to inefficient processing and user interfaces, many conventional digital-content-campaign systems inflexibly apply rules for segmentation. For instance, many conventional systems utilize rigid segment definitions that prevent the systems from effectively leveraging generated segments across disparate architectures of the system. Indeed, a segment generated by a computing environment of a conventional system may not be easily transferrable to, or interpretable by, an analytics database of the same conventional system. In addition, many conventional systems are fixed to a certain set of conventional target segments (e.g., conversions, clicks, or visits). Such conventional systems cannot therefore adapt to identify segments similar to different target segments at various levels of a web analytics hierarchy.

Thus, there are several disadvantages with regard to conventional digital-content-campaign systems.

### SUMMARY

This disclosure describes one or more embodiments of methods, non-transitory computer readable media, and systems that solve the foregoing problems in addition to providing other benefits. In particular, the disclosed systems can generate lookalike segments corresponding to a target segment using decision trees and provide a graphical user interface comprising nodes representing such lookalike segments. Upon receiving an indication of a target segment, for instance, the disclosed systems can generate a lookalike segment from a set of users by partitioning the set of users according to one or more dimensions based on probabilities of subsets of users matching the target segment. By partitioning subsets of users within a node tree, the disclosed systems can identify different subsets of users partitioned according to different dimensions from the set of users. The disclosed systems can further provide a node tree interface comprising a node for the set of users and nodes for subsets of users within one or more lookalike segments. By generating a decision tree directly on a columnar database, for instance, the disclosed systems can eliminate (or reduce) the latency in generating lookalike segments inhibiting conventional digital-content-campaign systems.

### BRIEF DESCRIPTION OF THE DRAWINGS

The detailed description refers to the drawings briefly described below.

FIG. 1 illustrates an example system environment for implementing a lookalike-segment-generation system in accordance with one or more embodiments;

FIG. 2 illustrates generating a node tree and providing a node tree interface in accordance with one or more embodiments;

FIG. 3 illustrates partitioning a parent node to generate child nodes in accordance with one or more embodiments;

FIG. 4 illustrates a graphical user interface for receiving a selection of a target segment in accordance with one or more embodiments;

FIG. 5 illustrates a graphical user interface for receiving a selection of a time interval in accordance with one or more embodiments;

FIG. 6 illustrates a graphical user interface for receiving selections of one or more dimensions in accordance with one or more embodiments;

FIG. 7 illustrates a node tree interface depicting a node tree in accordance with one or more embodiments;

FIG. 8 illustrates a node tree interface depicting node links in accordance with one or more embodiments;

FIG. 9 illustrates a node tree interface including a node window in accordance with one or more embodiments;

FIG. 10 illustrates a node tree interface including a node window in accordance with one or more embodiments;

FIG. 11 illustrates a schematic diagram of a lookalike-segment-generation system in accordance with one or more embodiments;

FIG. 12 illustrates a flowchart of a series of acts for generating and providing a node tree by partitioning nodes based on dimensions and a target segment in accordance with one or more embodiments;

FIG. 13 illustrates a series of acts involved in performing a step for generating a node tree comprising a first node of a subset of users and a second node of a subset of users partitioned from a set of users based on the one or more dimensions in accordance with one or more embodiments; and

FIG. 14 illustrates a block diagram of an example computing device in accordance with one or more embodiments.

### DETAILED DESCRIPTION

This disclosure describes one or more embodiments of a lookalike-segment-generation system that can generate lookalike segments corresponding to a target segment by partitioning a set of users utilizing a decision tree and provide a graphical user interface comprising nodes representing such lookalike segments. Upon receiving an indication of a target segment, for instance, the lookalike-segment-generation system can identify dimensions upon on which to partition a set of users into various nodes of a node tree based on probabilities of subsets of users matching the target segment. From such probabilities, the lookalike-segment-generation system can generate a node comprising a subset of users associated with values for a dimension and another node comprising another subset of users associated with different values for the dimension. By comparing target-matching probabilities corresponding to nodes to a threshold probability, the lookalike-segment-generation system can select one such node as a lookalike segment for the target segment. Based on generating a node tree, the lookalike-segment-generation system can provide a node tree interface comprising node elements for the set of users and one or more lookalike segments.

As mentioned, the lookalike-segment-generation system can identify a node as a lookalike segment comprising a subset of users who likely match a target segment. For instance, the lookalike-segment-generation system can identify (or indicate or isolate) a subset of users from a set of users that satisfy a threshold probability of matching the target segment. Such a threshold probability may indicate a probability of accomplishing a particular goal or matching particular attributes indicated by the target segment. To identify a lookalike segment, the lookalike-segment-generation system can generate a node tree by partitioning a set of users into nodes based on probabilities of subsets of users matching the target segment, where some nodes can have higher probabilities of matching the target segment and other nodes can have lower probabilities of matching the target segment.

To generate the nodes of the node tree, in some embodiments, the lookalike-segment-generation system can access a columnar database to identify one or more dimensions that indicate parameters or attributes for distinguishing between users of the set of users. To partition or split a given node of the node tree, the lookalike-segment-generation system can compare a plurality of candidate nodes that would result from possible partitions based on the one or more dimensions. As described below and depicted in various figures, the lookalike-segment-generation system can partition a root node representing a set of users or a child node representing a subset of users partitioned from the set of users.

To determine which dimensions upon which to partition a node, for example, the lookalike-segment-generation system can compare candidate nodes with other candidate nodes based on the same dimension, where different candidate nodes correspond to different dimension values of the dimension. Additionally, the lookalike-segment-generation system can compare candidate nodes based on a first dimension with candidate nodes based on a second dimension. In some embodiments, the lookalike-segment-generation system compares possible candidate nodes for possible dimensions across possible splits of values within each dimension. In some such cases, the lookalike-segment-generation system compares candidate nodes across all possible splits of values within all possible dimensions. Based on the comparison, the lookalike-segment-generation system can further select or determine candidate nodes (corresponding to a dimension and/or a division of constituent dimension values) for partitioning a node. As described below, the lookalike-segment-generation system further selects candidate nodes based on comparing probabilities of subsets of users within the candidate nodes matching a target segment.

To illustrate, the lookalike-segment-generation system can partition a parent node to generate a first child node and a second child node. To generate the child nodes, the lookalike-segment-generation system can identify a dimension from among multiple dimensions to use as a basis for partitioning the parent node as well as respective dimension values that belong to the first child node and the second child node. Indeed, the lookalike-segment-generation system can partition the parent node based on determining which dimension and dimension values would result in the first child node and the second child node satisfying a threshold gain in entropy with respect to their probabilities of matching the target segment. For instance, in some cases, the lookalike-segment-generation system partitions a parent node to generate child nodes that are more homogenous than the parent node in that the child nodes better partition users according to a dimension and/or more consistently partition users according to values of a particular dimension.

To generate a full node tree, the lookalike-segment-generation system can recursively partition nodes based on a gain in entropy with respect to a root node. For example, the lookalike-segment-generation system can recursively repeat the partitioning process for various nodes, splitting nodes into different child nodes corresponding to respective subsets of users. The lookalike-segment-generation system can partition each of the nodes based on respective probabilities of subsets of users within candidate nodes matching the target segment. The lookalike-segment-generation system can further determine that the node tree is complete (or determine to stop partitioning nodes) based on determining one or more stop criteria. For example, the lookalike-segment-generation system can determine that the node tree has reached a threshold depth and/or that one or more nodes of the node tree are smaller than a threshold size. By determining that a node within the node tree includes fewer than a threshold number of users as a result of the recursive partitioning process, for example, the lookalike-segment-generation system can determine that the node tree is complete.

As suggested above, the lookalike-segment-generation system can also generate and provide an interactive node tree interface for display on a client device. In some cases, the lookalike-segment-generation system provides a node tree interface comprising selectable options or other interactive interface elements for various parameters relevant to generating a lookalike segment in a unified location. By providing the node tree interface, for example, the lookalike-segment-generation system can include a unified graphical user interface comprising selectable options for an initial set of users, a target segment, dimensions for partitioning nodes to isolate users who match the target segment, and generate a node tree to identify a lookalike segment node. The node tree interface can include interactive node elements selectable to display node-specific information regarding dimensions, users, and probabilities of matching the target segment associated with individual nodes.

The lookalike-segment-generation system provides several advantages over conventional digital-content-campaign systems. For example, the lookalike-segment-generation system more efficiently generates a lookalike segment than conventional systems. In particular, as opposed to conventional systems that can take days or weeks to generate a lookalike segment, the lookalike-segment-generation system can extemporaneously generate a lookalike segment in an interactive fashion. Indeed, by recursively partitioning nodes based on identifying candidate nodes that maximize a gain in entropy, the lookalike-segment-generation system improves the speed with which conventional systems identify lookalike segments. Additionally, by generating a decision tree directly on a columnar database of user data within a population, for instance, the lookalike-segment-generation system reduces the latency and computational resources introduced by conventional systems in transferring data between environments to generate a lookalike segment. Thus, the lookalike-segment-generation system more efficiently utilizes computing resources, such as processing power and computing time as compared to conventional systems.

Because of the benefits of using a columnar database in generating a decision tree (i.e., a node tree), the lookalike-segment-generation system is also highly scalable. For instance, columnar databases generate interpretable decision rules, effectively handle class imbalance, and can operate with a range of criteria. Through the use of a columnar database in generating a node tree, the lookalike-segment-generation system is aware of hierarchies (e.g., a hierarchy of visitor, visit, hit) of user data. In addition, the lookalike-segment-generation system can be distributed across large scales (e.g., running on clusters of thousands of machines) and can efficiently use caching (so that data is reported quickly for repeat queries) and compression (e.g., “rez” format in AXLE). Experimenters have demonstrated that the lookalike-segment-generation system can generate a node tree for one billion users (with ten billion hits) in under five minutes. Additionally, experimenters have also demonstrated that the lookalike-segment-generation system can generate node trees over multiple (e.g., 3) years of analytics users in around 20 minutes, a task that conventional systems would entirely fail to complete.

The lookalike-segment-generation system further provides an improved and more efficient graphical user interface over conventional digital-content-campaign systems. As noted above, some conventional systems require users to navigate between multiple different interfaces to access information or functionality for transferring data and (separately) for building a supervised learning model. By contrast, in some embodiments, the lookalike-segment-generation system provides a node tree interface comprising selectable options or other interface elements to select target segments, select dimensions, and generate a lookalike segment all in a single location. Thus, the lookalike-segment-generation system processes fewer user interactions with a more efficient, informative user interface.

On top of improved efficiency, the lookalike-segment-generation system can more flexibly identify a lookalike segment than conventional digital-content-campaign systems. More specifically, unlike conventional systems that utilize rigid segment definitions that are not easily interpretable across different environments of the conventional systems, the lookalike-segment-generation system generates segments (e.g., nodes) that are naturally interpretable and easily leveraged across different environments (e.g., between different applications of an experience ecosystem). Indeed, the lookalike-segment-generation system defines segments in terms of dimensions and dimension values that are interpretable within different related systems across a marketing ecosystem (e.g., ADOBE EXPERIENCE CLOUD). Additionally, unlike many conventional systems that are limited to only a certain set of target segments, the lookalike-segment-generation system can adapt to identify lookalike segments based on a broad range of (user-defined) target segments at any level of a web analytics hierarchy. For example, the lookalike-segment-generation system can partition a root node representing a set of users into multiple levels of child nodes representing subsets of users, where some of the child nodes within the multi-level hierarchy represent lookalike segments.

As illustrated by the foregoing discussion, this disclosure utilizes a variety of terms to describe features and benefits of the lookalike-segment-generation system. As used in this disclosure, the term “segment” refers to a group of users whose network activities have been tracked and stored in a database (e.g., a columnar database). In particular, a segment can include an entire set or an entire population of users who share a common characteristic or can include a subset of users (within the overall set) who share a common characteristic. Such a common characteristic may include a common value for a dimension, such as a common action performed by users or a common attribute of users. In some cases, a segment can include a subset of users that belong to, or are otherwise represented by, a node within a node tree. In addition, the term “target segment” refers to a segment of users that satisfies search parameters or shares one or more common characteristics indicated by a user. Such a target segment may likewise represent users that satisfy a goal or represent users to which an entity seeks to distribute digital content. For example, a target segment can represent or indicate users who have performed a desired action (e.g., completing a purchase, clicking a link, repeated visits, or adding a product to an online shopping cart) and/or who have desired attributes (e.g., live in a particular geographic area, are of a particular age, or have a history of purchasing particular types of products).

Relatedly, as used herein, the term “node” refers to a segment of users partitioned within a node tree. In particular, a node can include users that correspond to one or more dimensions and/or particular values of the dimension(s). A node may also correspond to probabilities of users matching a target segment. For example, a node can include users that live in Washington state and are under 25 years old. As mentioned, a node can also correspond to a probability of matching a target segment, where users that belong to the node have a particular probability of matching the target segment based on the dimensions/dimension values of the node.

As mentioned, the lookalike-segment-generation system can generate, determine, or identify a lookalike segment. As used herein, the term “lookalike segment” (or “lookalike node”) refers to a subset of users that share one or more characteristics (e.g., dimension values) with a target segment. In particular, a lookalike segment can include a subset of users corresponding to a probability of matching a target segment that satisfies a threshold probability. In some embodiments, a lookalike segment can include a node within a node tree that includes users that satisfy a threshold probability of matching a target segment and that share at least one dimension value with a set or population of users. For example, a lookalike segment can include a subset of users with a probability of matching a target segment that meets or exceeds a multiplier value of accomplishing a target segment goal as compared to an initial set of users.

Relatedly, the term “threshold probability” refers to a threshold measure of likeness to a target segment or a threshold measure of accomplishing a goal associated with a target segment. In particular, a threshold probability can include a threshold percentage chance of matching a target segment or a percentage of users within a given node matching the target segment. In some embodiments, a threshold probability can include a threshold multiplier value that indicates a likelihood of matching a target segment as compared to an initial set of users as a baseline. For example, a threshold probability can indicate how many more times likely a node or a subset of users is to match the target segment (or accomplish a goal associated with a target segment) than the initial set of users. In some embodiments, different threshold probabilities can correspond to different percentage or multiplier values. For example, the lookalike-segment-generation system can visually indicate different nodes based on their satisfying different (e.g., scaled) threshold probabilities of matching a target segment.

Along these lines, a “node tree” refers to a collection of multiple nodes arranged in a hierarchy such that parent nodes split into child nodes (e.g., two child nodes for each parent node). Such a node tree may include a root node corresponding to the initial set or population of users. Indeed, the lookalike-segment-generation system can generate a node tree by partitioning nodes in accordance with probabilities of users within respective nodes matching a target segment based on dimensions and/or dimension values corresponding to users within the nodes. In some embodiments, a node tree refers to a decision tree that the lookalike-segment-generation system generates based on user data from a columnar database.

As mentioned, to determine how to partition a node, the lookalike-segment-generation system can compare candidate nodes. As used herein, the term “candidate node” (or simply “candidate”) refers to a node representing a possible or potential partition from a parent node. For example, a candidate node can correspond to a counterpart candidate node, each of the two candidate nodes having a respective dimension and dimension values that the lookalike-segment-generation system uses as a basis for testing probabilities of matching a target segment. Based on probabilities of users within a candidate node matching a target segment, the lookalike-segment-generation system can compare candidate nodes to identify those (pairs of candidate nodes) that satisfy a threshold gain in entropy with respect to the initial set of users.

As mentioned above, the lookalike-segment-generation system can identify one or more dimensions to use as a basis for partitioning nodes for generating a node tree. As used herein, the term “dimension” refers to set, category, or classification of values for organizing or attributing underlying data (e.g., a set of values for analyzing, grouping, or comparing event data). In particular, a dimension can include data related to a user that the lookalike-segment-generation system can use to distinguish one user from another user. For example, a dimension can include user data that modifies a target segment such as a dimension of “geographic location” modifying a target segment of “purchaser” to cause the lookalike-segment-generation system to generate a lookalike segment of purchasers based on geographic locations. In addition, dimensions can be broad categories of data or they can be narrow and specific. For instance, using states in the USA as a dimension, the lookalike-segment-generation system can distinguish between users who live in Washington, Oregon, Idaho, and Montana from users who live within all the other states. Example dimensions include geographic location (e.g., country, state, or city), browser, referrer, search engine, device type, product, webpage, gender, purchase, downloads, age, or digital content campaign.

In some embodiments, a dimension can include one or more constituent dimension values. As used herein, the term “dimension value” (or simply “value”) refers to a particular item in, or component of, a dimension. In particular, a value can include an individual item or data point within a collection of items or data points that make up a corresponding dimension. For example, a dimension value can be a particular product within a dimension of products. Other example values can include a webpage, a gender, a geographic location, a purchase, a download, or a page.

As also mentioned, the lookalike-segment-generation system can generate a lookalike segment in the form of a node that matches a target segment. As used herein, the term “match” (or its variants such as “matches” or “matching”) refers to a node or segment of users that is within (or above) a threshold similarity with respect to a target segment. For instance, a node or segment of users may correspond to one or more dimensions or dimension values in common with a target segment. In particular, a matching node can refer to a node that includes users who satisfy a threshold probability of matching a target segment. Matching nodes can include nodes with one or more of the same (or similar) dimensions and/or dimension values.

In addition, the lookalike-segment-generation system can partition nodes of a node tree based on identifying child nodes that satisfy a threshold gain in entropy. As used herein, the term “entropy” refers to a measure of uncertainty or a measure of variance within a set of data. In particular, entropy can include a measure of variance of dimension values associated with users of a particular node. The lookalike-segment-generation system can determine a gain in entropy for child nodes by determining how much entropy is removed from a particular node (e.g., a root node) in generating the child nodes.

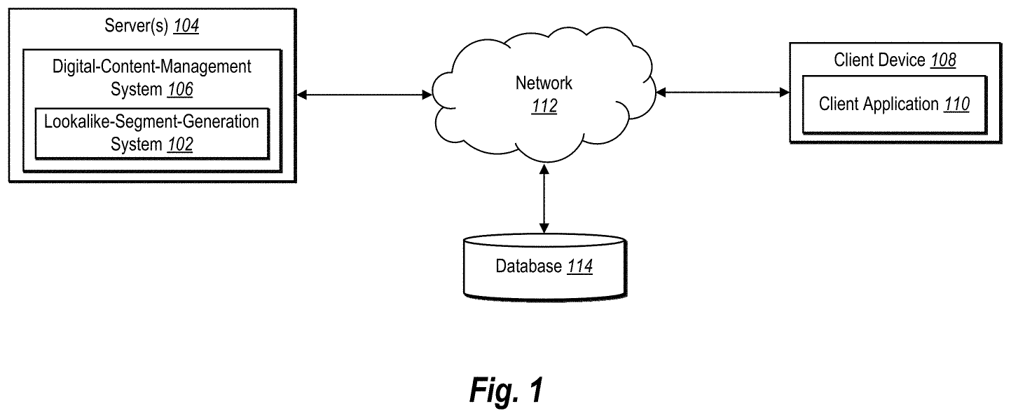

The following paragraphs provide additional detail regarding the lookalike-segment-generation system with reference to the figures. For example, FIG. 1 illustrates a schematic diagram of an example system environment for implementing a lookalike-segment-generation system 102 in accordance with one or more embodiments. An overview of the lookalike-segment-generation system 102 is described in relation to FIG. 1. Thereafter, a more detailed description of the components and processes of the lookalike-segment-generation system 102 is provided in relation to the subsequent figures.

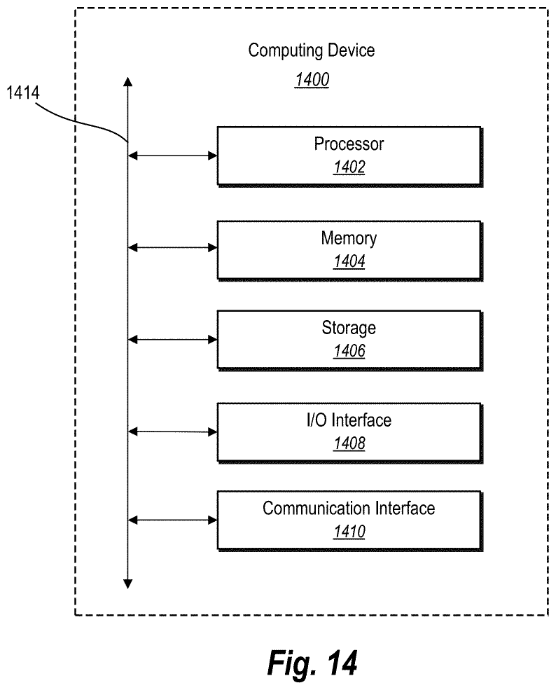

As shown, the environment includes server(s) 104, a client device 108, a database 114, and a network 112. Each of the components of the environment can communicate via the network 112, and the network 112 may be any suitable network over which computing devices can communicate. Example networks are discussed in more detail below in relation to FIG. 14.

As mentioned, the environment includes a client device 108. The client device 108 can be one of a variety of computing devices, including a smartphone, a tablet, a smart television, a desktop computer, a laptop computer, a virtual reality device, an augmented reality device, or another computing device as described in relation to FIG. 14. Although FIG. 1 illustrates a single client device, in some embodiments, the environment can include multiple different client devices, each associated with a different user. The client device 108 can communicate with the server(s) 104 via the network 112. For example, the client device 108 can receive user input from a user interacting with the client device 108 (e.g., via a client application 110) to receive an indication of a target segment, one or more dimensions, and/or a selection of a node. Thus, the lookalike-segment-generation system 102 on the server(s) 104 can receive information or instructions to generate a node tree and identify a lookalike segment based on input received by the client device 108.

As shown, the client device 108 includes the client application 110. The client application 110 may be a web application, a native application installed on the client device 108 (e.g., a mobile application, a desktop application, etc.), or a cloud-based application where all or part of the functionality is performed by the server(s) 104. The client application 110 can present or display information to a user, including a node tree interface that presents interactive elements for selecting target segments, dimensions, and other parameters. For example, the client application 110 can present a node tree interface with interactive node elements that, when selected, cause a node window to appear displaying node-specific information regarding how the node was partitioned from its parent node. A user can interact with the client application 110 to provide user input in the form of a selection, a click-and-drag, a typed search, or some other input type. Additional detail regarding the node tree interface is provided below with reference to subsequent figures.

As illustrated in FIG. 1, the environment includes the server(s) 104. The server(s) 104 may generate, track, store, process, receive, and transmit electronic data, such as user data arranged in a columnar database, target segments, dimensions, and dimension values. For example, the server(s) 104 may receive data from the client device 108 in the form of an input indicating a target segment. In addition, the server(s) 104 can transmit data to the client device 108 to provide a node tree interface that indicates one or more lookalike segments, such as nodes with at least a threshold probability of matching a target segment. Indeed, the server(s) 104 can communicate with the client device 108 to transmit and/or receive data via the network 112. In some embodiments, the server(s) 104 comprise a distributed set of servers where the server(s) 104 includes a number of server devices distributed across the network 112 and located in different physical locations. For instance, the server(s) 104 can comprise a digital content campaign server, a content server, an application server, a communication server, a web-hosting server, or a digital content management server.

As shown in FIG. 1, the server(s) 104 can also include the lookalike-segment-generation system 102 as part of a digital-content-management system 106. The digital-content-management system 106 can communicate with the client device 108 to generate and arrange a digital content campaign to distribute digital content in accordance with a target segment and/or identified lookalike segment(s). In addition, the digital-content-management system 106 and/or the lookalike-segment-generation system 102 can analyze the database 114 of user data (e.g., a columnar database) to generate a node tree based on probabilities of users matching a target segment in accordance with respective dimensions and dimension values. The lookalike-segment-generation system 102 can organize user data within the database 114 such that each row within the database represents a different user and each column represents a different dimension (or other metric).

Although FIG. 1 depicts the lookalike-segment-generation system 102 located on the server(s) 104, in some embodiments, the lookalike-segment-generation system 102 may be implemented by (e.g., located entirely or in part) on one or more other components of the environment. For example, the lookalike-segment-generation system 102 may be implemented by the client device 108 and/or a third-party device.

In some embodiments, though not illustrated in FIG. 1, the environment may have a different arrangement of components and/or may have a different number or set of components altogether. For example, the client device 108 may communicate directly with the lookalike-segment-generation system 102, bypassing the network 112. Rather than being located external to the server(s) 104, the database 114 can also be located on the server(s) 104 and/or on the client device 108.

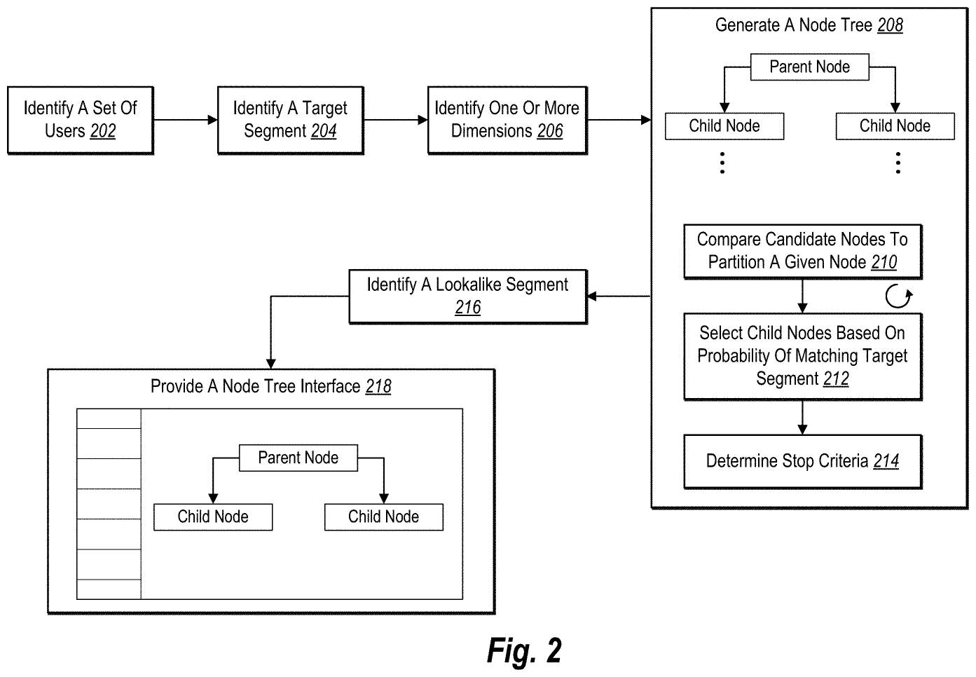

As mentioned, the lookalike-segment-generation system 102 can generate a node tree based on a set or a population of users. In particular, the lookalike-segment-generation system 102 can determine a target segment and one or more dimensions to use as a basis for partitioning the set of users into various nodes of a node tree, where each node includes a subset of users from the initial set of users. FIG. 2 illustrates a series of acts by which the lookalike-segment-generation system 102 generates a node tree and identifies a lookalike segment for providing to the client device 108 in accordance with one or more embodiments.

As illustrated in FIG. 2, the lookalike-segment-generation system 102 performs an act 202 to identify a set of users. For instance, the lookalike-segment-generation system 102 identifies a set of users to partition into subsets for identifying or isolating a lookalike segment in relation to a target segment. Put another way, the lookalike-segment-generation system 102 identifies a set of users to use as a root node of a node tree. In some embodiments, the lookalike-segment-generation system 102 identifies the set of users by receiving an indication or a selection from the client device 108. For example, the lookalike-segment-generation system 102 receives an indication to use a particular set of users, such as users within a particular geographic region, subscribers of a particular online system (e.g., a Software as a Service (“SAAS”) system such as ADOBE EXPERIENCE CLOUD), or users with a history of purchasing a particular type of product or service.

As shown in FIG. 2, the lookalike-segment-generation system 102 further performs an act 204 to identify a target segment. For instance, the lookalike-segment-generation system 102 identifies a target segment that indicates a goal of a digital content campaign or that represents a group of users to target with digital content. In some embodiments, the lookalike-segment-generation system 102 identifies the target segment by receiving an indication or a selection from the client device 108. For example, the lookalike-segment-generation system 102 receives an indication of a user selection of a target segment such as “Purchaser” or “Visits from Mobile Devices.” Additional detail regarding receiving an indication of a target segment from the client device 108 is provided below with reference to subsequent figures.

As further shown in FIG. 2, the lookalike-segment-generation system 102 performs an act 206 to identify one or more dimensions. In particular, the lookalike-segment-generation system 102 identifies or determines dimensions for distinguishing between users of the initial set of users. In some embodiments, the lookalike-segment-generation system 102 identifies a dimension by receiving an indication or a selection from a client device 108. For example, the lookalike-segment-generation system 102 receives an indication of a selection of dimensions such as “Country,” “Product,” and/or “Hour of Day.”

Based on identifying the one or more dimensions, the lookalike-segment-generation system 102 can further determine dimension values associated with each of the dimensions. For example, the lookalike-segment-generation system 102 can determine subcomponents or discrete items that belong to each dimension, such as a value of United States for the dimension “Country” or a value of 1:00 PM for the dimension “Hour of Day.”

Based on identifying the one or more dimensions, the target segment, and the set of users, the lookalike-segment-generation system 102 further performs an act 208 to generate a node tree. More particularly, the lookalike-segment-generation system 102 partitions the root node that corresponds to the initial set of users into two child nodes. The lookalike-segment-generation system 102 further partitions the child nodes into more nodes until one or more stop criteria are satisfied. Indeed, in some embodiments, the lookalike-segment-generation system 102 recursively repeats the partitioning of nodes based on the identified dimensions and dimension values until the node tree is complete (e.g., until one or more stop criteria are satisfied).

To partition a given node, as shown in FIG. 2, the lookalike-segment-generation system 102 performs acts 210-212. In particular, the lookalike-segment-generation system 102 performs an act 210 to compare candidate nodes to partition a given node (e.g., the root node or a different node). More specifically, the lookalike-segment-generation system 102 compares candidate nodes based on their respective probabilities of matching the target segment. To determine candidate nodes for comparison, the lookalike-segment-generation system 102 selects an individual dimension on which to partition the given node. For the selected dimension, the lookalike-segment-generation system 102 assigns different dimension values of the selected dimension to a first candidate node and to a second candidate node. The lookalike-segment-generation system 102 further compares the probabilities of each candidate node matching the target segment based on their respective dimension values. For partitioning the given node, the lookalike-segment-generation system 102 repeats the act 210 to compare candidate nodes associated with different dimensions and dimension values (until all possible dimension-and-dimension-value combinations are compared).

As an additional act involved in generating a node tree, in some embodiments, the lookalike-segment-generation system 102 performs an act 212 to select child nodes based on probabilities of various candidate nodes matching the target segment. To elaborate, the lookalike-segment-generation system 102 selects child nodes from the compared candidate nodes based on which candidate nodes have dimensions and dimension values that satisfy a particular criterion. For example, in some embodiments, the lookalike-segment-generation system 102 generates child nodes by selecting candidate nodes that, based on their respective probabilities of matching the target segment, satisfy a threshold gain in entropy with respect to the root node. Additional detail regarding generating child nodes based on a gain in entropy (or other criteria) is provided below with reference to subsequent figures.

As a further aspect of generating a node tree, in some cases, the lookalike-segment-generation system 102 performs an act 214 to determine stop criteria. In particular, upon determining that one or more stop criteria are satisfied, the lookalike-segment-generation system 102 stops partitioning nodes of the node tree (e.g., stops performing the acts 210-212). For example, the lookalike-segment-generation system 102 determines that the node tree has reached (or satisfies) a threshold depth. The depth of the node tree can correspond to the number of layers of nodes within the node tree and/or the number of partitions of nodes within the node tree. Thus, the lookalike-segment-generation system 102 can determine that the node tree has reached a threshold number of layers and/or a threshold number of partitions. As another example of a stop criterion, the lookalike-segment-generation system 102 determines that a node within the node tree is smaller than a threshold size (e.g., includes fewer than a threshold number of users).

Based on determining that one or more stop criteria are satisfied, the lookalike-segment-generation system 102 determines that the node tree is complete. Upon determining the node tree is complete, the lookalike-segment-generation system 102 performs an act 216 to identify a lookalike segment within the node tree. For example, the lookalike-segment-generation system 102 identifies a lookalike segment as a node (within the node tree) corresponding to a probability that satisfies a threshold probability of matching the target segment. In some embodiments, the lookalike-segment-generation system 102 identifies multiple nodes corresponding to probabilities that satisfy a threshold probability of matching the target segment as lookalike segments. In some cases, the lookalike-segment-generation system 102 identifies a lookalike segment as a node with a highest probability of matching the target segment as compared to other nodes within the node tree (e.g., as compared with all the nodes of the entire node tree or as compared with other nodes at the same level within the node tree).

As illustrated in FIG. 2, the lookalike-segment-generation system 102 performs an act 218 to provide a node tree interface. More particularly, the lookalike-segment-generation system 102 generates and provides a node tree interface for display on the client device 108. For example, the lookalike-segment-generation system 102 provides a node tree interface that portrays the node tree generated in act 208. In some embodiments, the lookalike-segment-generation system 102 further indicates a node within the node tree interface that is identified as a lookalike segment. For example, the lookalike-segment-generation system 102 utilizes visual indicators (e.g., heat map highlighting) to highlight or otherwise mark one or more nodes within the node tree interface with various colors (or shading or patterning) to indicate those nodes that are above a threshold probability of matching the target segment and/or those nodes that are below a threshold probability of matching the target segment. Additional detail regarding the node tree interface and indicating various aspects of a generated node tree is provided below with reference to subsequent figures.

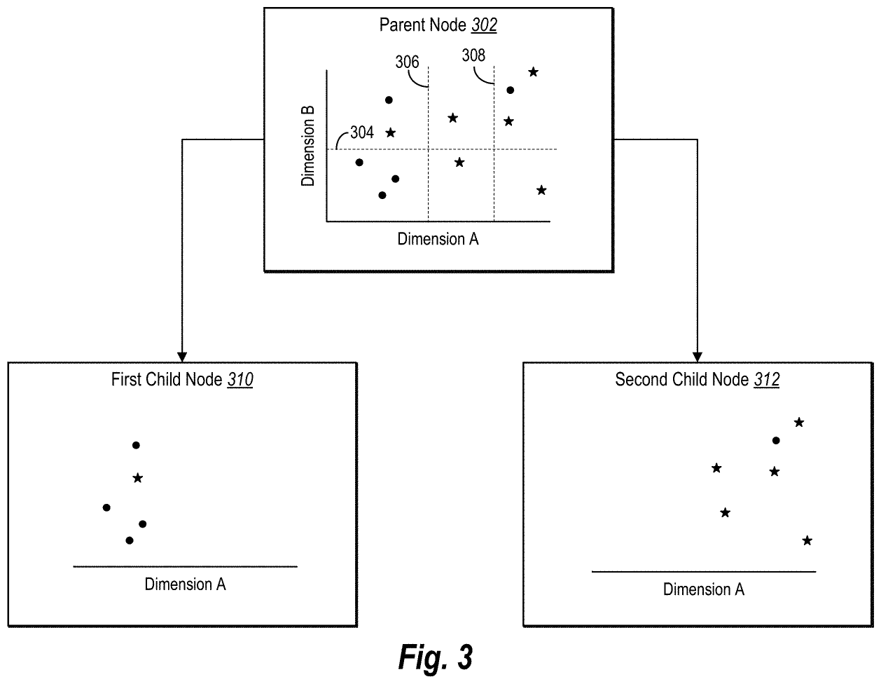

As mentioned above, the lookalike-segment-generation system 102 can partition nodes to generate a node tree. In particular, the lookalike-segment-generation system 102 can partition nodes starting with a root node that includes an initial set of users. By partitioning the root node, the lookalike-segment-generation system 102 can generate two child nodes (where the root node is a parent node). The lookalike-segment-generation system 102 can further partition the child nodes into additional child nodes as described herein. FIG. 3 illustrates partitioning a parent node 302 into a first child node 310 and a second child node 312 based on dimensions associated with the parent node 302 in accordance with one or more embodiments.

As shown, the parent node 302 includes a number of users represented by dots and stars. For instance, the users represented by dots may have a first combination of values, and the users represented by stars may have a second combination values. To partition the parent node 302 into the first child node 310 and the second child node 312, the lookalike-segment-generation system 102 analyzes the dot users and the star users to compare candidate nodes. To generate candidate nodes for comparison, in some cases, the lookalike-segment-generation system 102 selects one of Dimension A or Dimension B and partitions the users based on the selected dimension. For example, the lookalike-segment-generation system 102 examines different partitions or splits of the parent node 302 by selecting a dimension and assigning different values of the dimension to a first candidate node and a second candidate node to analyze. The lookalike-segment-generation system 102 further determines one of Dimension A or Dimension B upon which to partition the parent node 302 based on how the assigned values affect the probabilities of matching the target segment of the first candidate node and the second candidate node.

As illustrated in FIG. 3, the lookalike-segment-generation system 102 generates a first pair of candidate nodes based on testing a split over the test partition 304, generates a second pair of candidate nodes over the test partition 306, and generates a third pair of candidate nodes over the test partition 308. To elaborate, the lookalike-segment-generation system 102 generates the first pair of candidate nodes over the test partition 304 by (i) selecting Dimension B and (ii) placing users whose dimension values in Dimension B are above a value for the test partition 304 into a first candidate node and users whose dimension values are below the value for the test partition 304 into a second candidate node. Based on the test partition 304, the first candidate node includes four star users and two dot users while the second candidate node includes two star users and three dot users.

Additionally, the lookalike-segment-generation system 102 analyzes a second test partition 306 by (i) selecting Dimension A and (ii) assigning users whose values in Dimension A are above a value for the test partition 306 to a first candidate node and users whose values are below a value for the test partition 306 to a second candidate node. Thus, the lookalike-segment-generation system 102 generates the first candidate node to include four dot users and one star user and generates the second candidate node to include one dot user and five star users.

Further, the lookalike-segment-generation system 102 analyzes a third test partition 308. In particular, the lookalike-segment-generation system 102 (i) selects Dimension A and (ii) assigns users whose values of Dimension A are above a value for the test partition 308 to a first candidate node and users whose values are below the value for the test partition 308 to a second candidate node. Thus, the lookalike-segment-generation system 102 generates a first candidate node that includes four dot users and three star users and generates a second candidate node that includes one dot user and three star users.

While FIG. 3 illustrates only three different test partitions 304-308, additional test partitions are possible. For example, in some embodiments, the lookalike-segment-generation system 102 tests every possible partition over each of Dimension A and Dimension B by assigning different combinations of values to different candidate nodes. By testing the various candidate nodes associated with different dimensions and dimension values, the lookalike-segment-generation system 102 determines which candidate nodes satisfy a particular criterion.

For example, the lookalike-segment-generation system 102 analyzes the different test partitions 304-308 to determine which test partition results in candidate nodes that satisfy a threshold gain in entropy (with respect to the parent node 302). To elaborate, the lookalike-segment-generation system 102 determines which candidate nodes reduce a measure of entropy associated with the parent node 302 by a threshold amount. As shown in FIG. 3, the parent node 302 includes five dot users and six star users, which results in a relatively high entropy value within the parent node 302. Thus, the lookalike-segment-generation system 102 analyzes the test partitions 304-308 to determine a test partition that satisfies a threshold gain in entropy (or that reduces the entropy of the parent node 302 by a threshold amount), or that has a higher gain in entropy than the other test partitions. Indeed, the lookalike-segment-generation system 102 determines a test partition that reduces entropy of a parent node (or a root node) to result in child nodes that include users with more similar dimension values than the parent node (or the root node).

As shown, the lookalike-segment-generation system 102 selects the test partition 306 to generate the first child node 310 and the second child node 312. Indeed, the lookalike-segment-generation system 102 determines that the candidate nodes associated with the test partition 306 satisfy a threshold gain in entropy by splitting users into more homogenous groups. Thus, the lookalike-segment-generation system 102 generates the first child node 310 and the second child node 312 by partitioning the parent node 302 over Dimension A, with users with values above the value for the test partition 306 assigned to the first child node 310 and users with values below the value for the test partition 306 assigned to the second child node 312.

Although FIG. 3 illustrates only two dimensions and only a certain number of users within the parent node 302, this is merely for illustrative purposes and different numbers of dimensions and/or users are possible. Indeed, the lookalike-segment-generation system 102 can partition a parent node associated with any number of possible dimensions, where each dimension includes any number of dimension values. For example, the lookalike-segment-generation system 102 can partition a parent node by evaluating candidate nodes over 15 different dimensions, each with its own set of dimension values, to select as child nodes those candidate nodes that satisfy a particular criterion (e.g., a threshold level of gain in entropy).

To determine a gain in entropy associated with a given test partition (or given candidate nodes), the lookalike-segment-generation system 102 determines probabilities of the candidate nodes matching a target segment based on their respective dimension(s) and dimension value(s). In some embodiments, given a target segment y and dimensions x over which to search for a lookalike segment for the target segment y, the lookalike-segment-generation system 102 can determine a target value Tᵢ of the i^{th} user, where Tᵢ is a binary variable (either 0 or 1) and is an exhaustive partition of all observations. Further, the lookalike-segment-generation system 102 can define Π_{D}¹ as a distribution for the subset of Tᵢ=1 and Π_{D}⁰ as a distribution for the subset of Tᵢ=0. That is, if D¹, D², . . . , D^{k} are the possible values for the dimension D, then Π_{D}¹ describes the full set of probabilities of the form π₁^{j}=P(D=D^{j}|Tᵢ=1) for all j. Similarly, Π_{D}⁰ describes the full set of probabilities of the form π₀^{j}=P(D=D^{j}|Tᵢ=0) for all j. From user data, the lookalike-segment-generation system 102 can query the frequency estimates of these probabilities—that is, two queries on the columnar database 114 yields Π_{D}¹ and Π_{D}⁰.

In a given node (e.g., the parent node 302), there are i=1, . . . , N units, and the lookalike-segment-generation system 102 analyzes test partitions of the node into two candidate child nodes of size N₁ and N₂, where N₁+N₂=N. The lookalike-segment-generation system 102 defines the two candidate child nodes (e.g., a left candidate child node and a right candidate child node) as:

$${𝒞}_{l} = \{ i : {D}_{j} ∈ {𝒟}_{j}^{l} = \{ {D}^{{l}_{1}} , … , {D}^{{l}_{{k}_{1}}} \} \} and$$

$${𝒞}_{r} = \{ i : {D}_{j} ∈ {𝒟}_{j}^{r} = \{ {D}^{{r}_{1}} , … , {D}^{{r}_{{k}_{2}}} \} \}$$

where j represents a dimension over which to partition the given node (e.g., the parent node 302) and where [symbol] and [symbol] are sets of dimension values (within the dimension j) associated with the left child node (e.g., the first child node 310) and the right child node (e.g., the second child node 312), respectively.

To determine dimension j, set of dimension values [symbol] , and set of dimension values [symbol] , the lookalike-segment-generation system 102 determines the probabilities of the candidate child nodes matching the target segment. To elaborate, the lookalike-segment-generation system 102 can define a parent node (e.g., the parent node 302) as:

[symbol]

= [symbol] ∪

[symbol]

In addition, the lookalike-segment-generation system 102 can determine the probabilities of [symbol] and [symbol] matching the target segment y as:

P(Tᵢ=1| [symbol] ) and

P(Tᵢ=1| [symbol] )

where P(Tᵢ=1| [symbol] ) and P(Tᵢ=1| [symbol] ) diverge from P(Tᵢ=1| [symbol] ).

In some embodiments, as mentioned above, the lookalike-segment-generation system 102 considers the entropy of the parent node (e.g., the parent node 302) and the candidate child nodes. For example, the lookalike-segment-generation system 102 defines the entropy of the parent node as:

[symbol]

=−P(Tᵢ=1| [symbol] )log P(Tᵢ=1| [symbol] )−(1−P(Tᵢ=1| [symbol] ))log(1−P(Tᵢ=1| [symbol] ))

In a similar fashion, the lookalike-segment-generation system 102 defines the entropy of the left candidate child node and the right candidate child node as:

[symbol]

=−P(Tᵢ=1| [symbol] )log P(Tᵢ=1| [symbol] )−(1−P(Tᵢ=1| [symbol] ))log(1−P(Tᵢ=1| [symbol] )) and

[symbol]

=−P(Tᵢ=1| [symbol] )log P(Tᵢ=1| [symbol] )−(1−P(Tᵢ=1| [symbol] )log(1−P(Tᵢ=1| [symbol] )).

In some embodiments, the lookalike-segment-generation system 102 determines entropies for various candidate nodes that result from various test partitions (e.g., the test partitions 304-308) to determine which candidate nodes result in a threshold gain in entropy. For example, the lookalike-segment-generation system 102 determines which candidate nodes maximize gain in entropy. More specifically, the lookalike-segment-generation system 102 determines gain in entropy between a left child node and a right child node (or between a left candidate node and a right candidate node) in accordance with:

$$\frac{\vert {𝒞}_{l} \vert}{\vert 𝒫 \vert} {E}_{{𝒞}_{l}} + \frac{\vert {𝒞}_{r} \vert}{\vert 𝒫 \vert} {E}_{{𝒞}_{r}} - {E}_{𝒫} .$$

Because the lookalike-segment-generation system 102 defines candidate child nodes (e.g., [symbol] and [symbol] ) in terms of a dimension (e.g., Dimension A), determining which candidate nodes to select as child nodes (e.g., the first child node 310 and the second child node 312) can, in some embodiments, require the lookalike-segment-generation system 102 to consider all possible test partitions of values within each possible dimension. In one or more embodiments, the lookalike-segment-generation system 102 efficiently evaluates all possible candidate nodes associated with each possible test partition using a linear pass across the candidate nodes (or the values of a given dimension) by arranging the candidate nodes (or the dimension values) according to increasing probabilities of matching the target segment. For example, in some embodiments, the lookalike-segment-generation system 102 utilizes the ordering technique described by Trevor Hastie et al., The Elements of Statistical Learning: Data Mining, Interference and Prediction, The Mathematical Intelligencer 27, No. 2, 83-85 (2005), the entire contents of which are hereby incorporated by reference.

To continue generating a node tree, as described above, the lookalike-segment-generation system 102 repeats the partitioning process by, for various nodes in the node tree, determining entropies of candidate child nodes and selecting child nodes based on their probabilities of matching the target segment until one or more stop criteria are satisfied. In some embodiments, for instance, the lookalike-segment-generation system 102 recursively repeats the node partitioning routine—i.e., the process of defining candidate child nodes, defining probabilities of the candidate child nodes matching the target segment, determining a gain in entropy associated with the candidate child nodes, and selecting child nodes from the candidate child nodes—until the node tree has satisfied a threshold depth or until a child node within the node tree includes fewer than a threshold number of users.

As the lookalike-segment-generation system 102 continues to partition nodes as part of generating a node tree, the number of queries to the database 114 each time the lookalike-segment-generation system 102 partitions a node is twice the number of dimensions. Thus, for efficient processing, in some embodiments, the lookalike-segment-generation system 102 performs a linear pass through the values of each dimension to determine the best partition (e.g., to determine which candidate nodes satisfy a threshold gain in entropy).

As shown, the lookalike-segment-generation system 102 compares candidate nodes that result from analyzing the test partitions 304-308 of the parent node 302. In some embodiments, the lookalike-segment-generation system 102 generates child nodes (e.g., the first child node 310 and the second child node 312) that exhibit extreme class imbalance, where one child node has far more users than the other child node (e.g., 10 to 1 or 100 to 1). For example, less than 1% of visitors to an ecommerce site may place an order, so a child node that includes visitors to the site may have 100 users, whereas a child node that includes purchasers may have only a single user. To handle this imbalance, the lookalike-segment-generation system 102 weights rare classes (e.g., groups of users that have fewer than a threshold number of users or a threshold percentage of the users from among the initial set of users). For example, in some embodiments, the lookalike-segment-generation system 102 weights a rare class up by a factor of:

|Tᵢ=1|/|Tᵢ=0|

within the root node of the node tree. Thus, the lookalike-segment-generation system 102 can avoid biased sampling of rare and common classes by weighting probabilities that a given subset of users match a target segment based on a number of users within the subset and a number of users within the initial set of users.

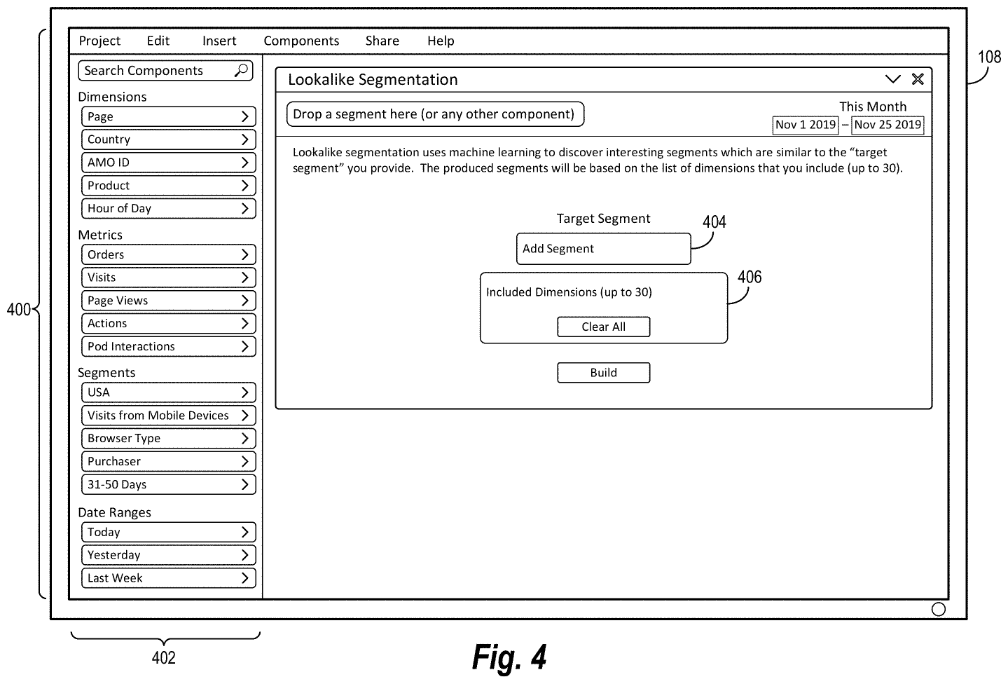

As noted above, in some embodiments, the lookalike-segment-generation system 102 can generate a node tree for display within a graphical user interface. In accordance with one or more embodiments, FIGS. 4-10 illustrate the client device 108 presenting graphical user interfaces comprising options or parameters for a target segment and a node tree comprising nodes for lookalike segments. As explained below, the lookalike-segment-generation system 102 provides data to the client device 108 to display such a node tree in response to various user inputs within graphical user interfaces. FIGS. 4-10 likewise each depict the client device 108 comprising the client application 110 for the lookalike-segment-generation system 102. In some embodiments, the client application 110 comprises computer-executable instructions that cause the client device 108 to perform certain actions depicted in FIGS. 4-10, such as presenting a node tree interface of the client application 110.

As mentioned, the lookalike-segment-generation system 102 can identify a target segment. In particular, the lookalike-segment-generation system 102 can receive an indication of a target segment from a set of possible target segments. In some embodiments, the lookalike-segment-generation system 102 receives a user input to select a target segment from a listed set of target segments within a node tree interface. In accordance with one or more embodiment, FIG. 4 illustrates a graphical user interface 400 displayed on the client device 108 that the lookalike-segment-generation system 102 generates and provides to the client device 108s.

In providing data for the graphical user interface 400 of FIG. 4, the lookalike-segment-generation system 102 provides a parameter selection portion 402 from which a user can select dimensions, target segments, time intervals, and/or other parameters for generating a node tree. For example, the lookalike-segment-generation system 102 provides a target segment field 404 for receiving an indication of a target segment. Particularly, the lookalike-segment-generation system 102 receives a selection (from the parameter selection portion 402) of a particular segment within the target segment field 404, such “Purchaser” or “Visits from Mobile Devices” to designate as a target segment. In some embodiments, the lookalike-segment-generation system 102 receives more than one segment within the target segment field 404 and generates a composite target segment based on a combination of the multiple selected segments.

As shown in FIG. 4, the lookalike-segment-generation system 102 also provides a dimension field 406. In particular, the lookalike-segment-generation system 102 receives an indication (from the parameter selection portion 402) of one or more dimensions within the dimension field 406. For example, the lookalike-segment-generation system 102 receives an indication of a selection of a dimension from the client device 108, such as “Country,” “Product,” or “Hour of Day.” In some embodiments, the lookalike-segment-generation system 102 receives multiple dimensions up to a threshold number (e.g., 30 dimensions) within the dimension field 406. Based on the dimensions, the lookalike-segment-generation system 102 generates a node tree that indicates one or more lookalike segments for the target segment. Additional detail regarding generating the node tree based on the dimensions and the target segment is provided above.

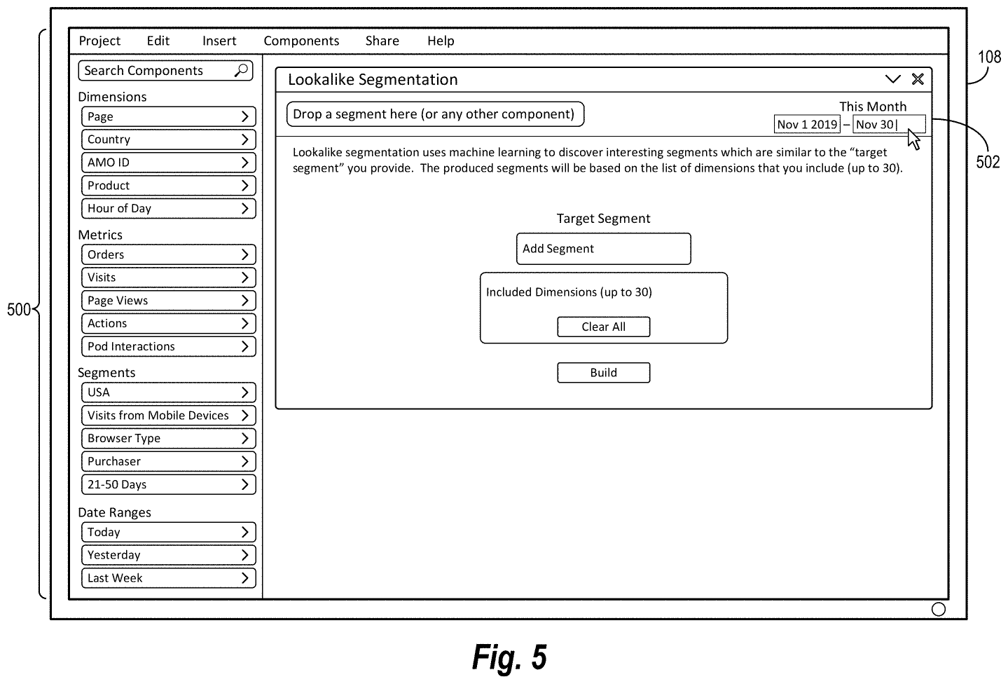

In addition to receiving indications of target segments and/or dimensions, in some cases, the lookalike-segment-generation system 102 further receives an indication of a time interval. In particular, the lookalike-segment-generation system 102 can receive user input indicating a start time and a stop time that define a time interval from which to generate a lookalike segment. Indeed, the lookalike-segment-generation system 102 can utilize a time interval to identify time-specific-user data to within the database 114 from which to generate a node tree. FIG. 5 illustrates providing a time interval field 502 within the graphical user interface 500 by which the lookalike-segment-generation system 102 receives time interval input in accordance with one or more embodiments.

As shown in FIG. 5, the lookalike-segment-generation system 102 receives, via a graphical user interface 500, an input for a time interval that defines a period of time for analyzing user data. More specifically, the lookalike-segment-generation system 102 maintains the database 114 of user data (e.g., a columnar database). In some cases, the lookalike-segment-generation system 102 utilizes an indicated time interval to define bounds over which the lookalike-segment-generation system 102 analyzes user data to generate a node tree. As an example, the lookalike-segment-generation system 102 receives an indication of a time interval within the time interval field 502, and the lookalike-segment-generation system 102 uses the time interval as a modifier for the target segment (and/or the dimensions) selected by the user. For a target segment of “Purchaser,” for instance, the lookalike-segment-generation system 102 modifies the target segment using a time interval from Nov. 1, 2019 to Nov. 30, 2019 to identify a lookalike segment from Nov. 1, 2019 to Nov. 30, 2019.

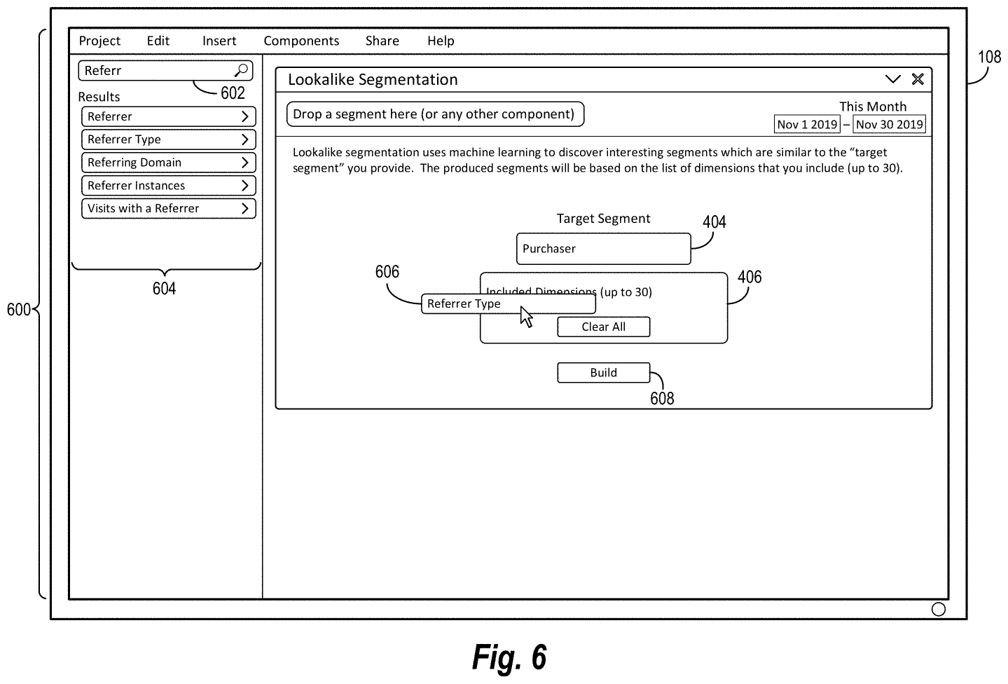

As mentioned, in addition to identifying a target segment, the lookalike-segment-generation system 102 can identify one or more dimensions for partitioning a set or population of users. In particular, the lookalike-segment-generation system 102 can receive a user input selecting a dimension to use as a basis for distinguishing between users of the set of users in isolating or identifying those users that have a higher probability of matching the target segment. FIG. 6 illustrates receiving an indication of one or more dimensions via the graphical user interface 600 in accordance with one or more embodiments.

As shown in FIG. 6, the lookalike-segment-generation system 102 receives an indication of a dimension 606 of “Referrer Type.” To enable a user to locate the dimension 606, in some embodiments, the lookalike-segment-generation system 102 provides a scrolling function within the parameter selection portion 402 as well as search field 602 whereby the lookalike-segment-generation system 102 can receive a query of one or more characters to search a repository of dimensions (or other metrics). For example, as shown in FIG. 6, the lookalike-segment-generation system 102 receives a query of “Referr,” which the lookalike-segment-generation system 102 uses to search for and identify a number of corresponding dimensions within the query results 604. Based on the query results 604, the lookalike-segment-generation system 102 receives a selection (e.g., a click-and-drag) of the dimension 606 to drop the dimension 606 within the dimension field 406.

In addition to the dimension 606, in some embodiments, the lookalike-segment-generation system 102 receives other dimensions as well. For example, the lookalike-segment-generation system 102 receives dimensions such as “Country,” “Product,” or others added to the dimension field 406. In some embodiments, the lookalike-segment-generation system 102 receives up to a threshold number (e.g., 30 or more) of dimensions. As described above, based on one or both of the dimension 606 and the other dimensions, the lookalike-segment-generation system 102 determines how to partition a set of users into subsets (e.g., nodes) based on probabilities of matching a target segment.

Based on receiving a target segment of “Purchaser” and dimensions of “Referrer Type,” “Country,” and “Product,” for instance, the lookalike-segment-generation system 102 determines how to partition a set of users into nodes of a node tree. For example, the lookalike-segment-generation system 102 receives a user input indicating a selection of a segment-generation option 608. In response to receiving an indication of the selection of the segment-generation option 608, the lookalike-segment-generation system 102 generates a node tree by partitioning users from the set of users into subsets for nodes of the node tree.

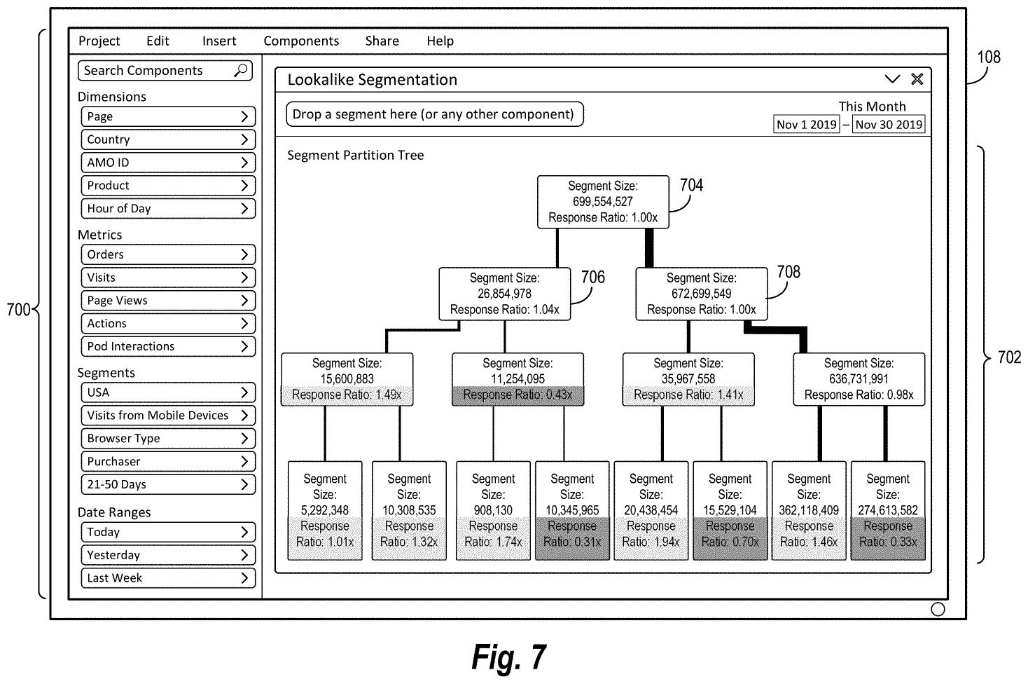

As described above, the lookalike-segment-generation system 102 can partition an initial set or population of users into nodes based on their respective dimensions/values and corresponding probabilities of matching the target segment. FIG. 7 illustrates a node tree 702 displayed within a node tree interface 700 that the lookalike-segment-generation system 102 generates in accordance with one or more embodiments. As depicted in FIG. 7, the lookalike-segment-generation system 102 generates and provides the node tree interface 700 for display on the client device 108 based on receiving a target segment of “Purchaser” and dimensions of “Referrer Type,” “Country,” and “Product.”

As illustrated in FIG. 7, the node tree interface 700 comprises the node tree 702 that includes a root node element 704 portraying information pertaining to a root node, a first child node element 706 portraying information pertaining to a first child node, and a second child node element 708 portraying information pertaining to a second child node. Similar to the discussion above, the lookalike-segment-generation system 102 provides the root node element 704 representing an initial set or population of users. In some embodiments, the lookalike-segment-generation system 102 receives an indication from the client device 108 of the set of users (e.g., via the graphical user interface 400). For instance, the lookalike-segment-generation system 102 receives a user input to select a set of users from which the lookalike-segment-generation system 102 identifies a lookalike segment. Such sets of users can include users of a particular system, users in a particular geographic area, users of a particular age, or other sets of users.

As mentioned, in some embodiments, the lookalike-segment-generation system 102 utilizes the database 114 to generate the node tree 702 by partitioning the root node element 704. In some cases, the lookalike-segment-generation system 102 accesses information from a columnar database where columns within the columnar database correspond to respective dimensions and where rows within the columnar database correspond to respective users. For example, the database 114 can include ADOBE AXLE and/or other open source options, such as MONETDB, CASSANDRA, or PARQUET, or commercial options such as AMAZON RED SHIFT or GOOGLE DREMEL However, none of these columnar databases are suitable for building machine learning models associated with conventional systems. As suggested above, many machine learning models of conventional systems require the entire row of observation for a unit of analysis, where the entire row contains the response as well as a vector of the corresponding features. Columnar databases are generally incompatible with this type of query, which renders their application impossible in most conventional systems.

By generating a decision tree over the database 114 as a columnar database, on the other hand, the lookalike-segment-generation system 102 overcomes the drawbacks of many conventional systems. For example, the lookalike-segment-generation system 102 can generate a decision tree over a columnar database (e.g., the database 114) to cut a feature space of the decision tree into steps using a simple basis function so it is possible to define the necessary queries efficiently. For example, the lookalike-segment-generation system 102 can apply decision trees including, but not limited to, classification decision trees, regression decision trees, and C4.5 decision trees.

As further shown in FIG. 7, the lookalike-segment-generation system 102 partitions the root node element 704 to generate the first child node element 706 and the second child node element 708. In particular, the lookalike-segment-generation system 102 generates the first child node element 706 that includes a first number of users partitioned from the root node element 704. In addition, the lookalike-segment-generation system 102 generates the second child node element 708 that includes a second number of users partitioned from the root node element 704.

To partition the root node element 704 into the first child node element 706 and the second child node element 708, the lookalike-segment-generation system 102 compares a plurality of candidate nodes, as described above. For instance, the lookalike-segment-generation system 102 compares candidate nodes that result from partitioning the root node element 704 based on various combinations of dimensions and dimension values. To generate the first child node element 706 and the second child node element 708, the lookalike-segment-generation system 102 selects a dimension (of the one or more dimensions received via the graphical user interface 400) and determines which values of the dimension to assign to each candidate node. Indeed, the lookalike-segment-generation system 102 bases this selection on probabilities of the various candidate nodes matching the target segment based on their respective dimensions and dimension values.

In some embodiments, the lookalike-segment-generation system 102 compares all possible candidate nodes that could split from the root node element 704 based on all different combinations of dimensions and all possible partitions of dimension values within those dimensions. Based on determining which candidate nodes satisfy a threshold gain in entropy, the lookalike-segment-generation system 102 can partition the root node element 704 into the first child node element 706 and the second child node element 708.

In a similar fashion, the lookalike-segment-generation system 102 can further partition the first child node element 706 and the second child node element 708 to generate additional child nodes. Indeed, the lookalike-segment-generation system 102 can recursively repeat comparing candidate nodes based on different dimension-and-dimension-value combinations and corresponding node probabilities of matching the target segment. Thus, as shown in FIG. 7, the lookalike-segment-generation system 102 can generate the node tree 702 by recursively repeating the process of partitioning nodes until one or more stop criteria are met, as described above.

As mentioned above, the lookalike-segment-generation system 102 identifies one of the nodes within the node tree 702 as a lookalike segment. In some embodiments, for instance, the lookalike-segment-generation system 102 provides visual indicators for nodes of the node tree 702. For example, the lookalike-segment-generation system 102 provides visual indicators to indicate which nodes have higher probabilities of matching the target segment and which nodes have lower probabilities of matching the target segment. In some embodiments, the lookalike-segment-generation system 102 provides shaded and/or colored visual indicators in the form of heat map highlighting, where lighter shades of highlighting correspond to higher probabilities and darker shades correspond to lower probabilities.

In some embodiments, the lookalike-segment-generation system 102 provides colored visual indicators where particular colors indicate corresponding probability ranges. For instance, the lookalike-segment-generation system 102 provides heat map highlighting where green indicates a probability above a threshold and red indicates a probability below a threshold (and where darker shades of green indicate higher probabilities and darker shades of red indicate lower probabilities). In one or more embodiments, the lookalike-segment-generation system 102 indicates a lookalike segment with a particular color (e.g., a green node or a dark green node).

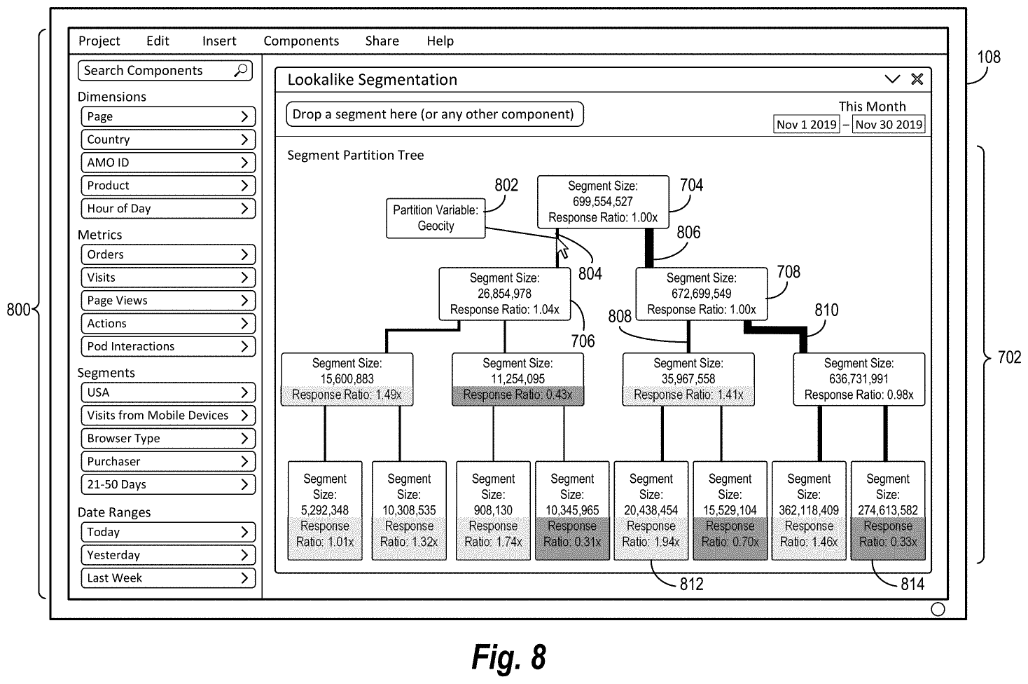

FIG. 8 illustrates client device 108 presenting a node tree interface 800 comprising the node tree 702 with visual indicators in accordance with one or more embodiments. As shown in FIG. 8, the lookalike-segment-generation system 102 provides nodes with particular colors and/or shades corresponding to probabilities of matching the target segment. For example, the lookalike-segment-generation system 102 generates and provides the node 812 for display with a high probability of matching the target segment (i.e., a high “response ratio” as shown within the node) at 1.94 times that of the root node. The lookalike-segment-generation system 102 highlights the node 812 accordingly (e.g., with a particular color or darker shading). In addition, the lookalike-segment-generation system 102 generates and provides the node 814 for display with a low probability of matching the target segment at 0.33 times that of the root node. The lookalike-segment-generation system 102 highlights the node 814 accordingly (e.g., with a particular color or lighter shading). Additionally, the lookalike-segment-generation system 102 provides other segment information within each node of the node tree 702, such as segment sizes that indicate the numbers of users within respective nodes.

By generating the node tree 702 and highlighting various nodes, the lookalike-segment-generation system 102 can surface both closely matched and distantly matched segments for a target segment—including lookalike segments with users matching the target segment to varying degrees. Indeed, not only are lookalike segments useful in many situations, but segments that are less matched to a target segment are also useful in certain situations. Thus, compared to conventional systems that may surface only certain segments, the lookalike-segment-generation system 102 provides greater depth of useful information for application in a variety of scenarios.

As further illustrated in FIG. 8, the lookalike-segment-generation system 102 provides node links 804-810 for display between nodes of the node tree 702. For example, the lookalike-segment-generation system 102 provides node links 804 and 806 from the root node element 704 to the first child node element 706 and the second child node element 708. As shown in FIG. 8, the node link 806 is thicker (or heavier or wider) than the node link 804. Indeed, the lookalike-segment-generation system 102 provides the node links 804 and 806 for display with thicknesses that correspond to a number or a proportion of users partitioned from the parent node (e.g., the root node) to respective child nodes (e.g., the first child node element 706 and the second child node element 708).

To illustrate, in some embodiments, the first child node element 706 includes 25,854,978 users while the second child node element 708 includes 672,699,549 users. Based on the comparative sizes of the child nodes, the lookalike-segment-generation system 102 provides the node link 806 for display with a thicker outline than the node link 804. Similarly, the lookalike-segment-generation system 102 provides other node links between nodes, such as the node link 808 and the node link 810, that reflect respective numbers or proportions of users partitioned from a parent node to a child node. In some embodiments, the lookalike-segment-generation system 102 generates, or determines the thickness of, the node links 804-810 based on logarithmic scale to handle imbalanced partitions.

As further illustrated in FIG. 8, the lookalike-segment-generation system 102 can provide a node link window based on a user interaction. For example, in response to receiving an indication of a selection of (e.g., a click of or a hover over) the node link 804, the lookalike-segment-generation system 102 provides the node link window 802 for display on the client device 108. Within the node link window 802, the lookalike-segment-generation system indicates a dimension (e.g., the “partition variable”) that the lookalike-segment-generation system 102 used to partition users from the parent node (e.g., the root node element 704) to the respective child node (e.g., the first child node element 706). Indeed, as shown in FIG. 8, the lookalike-segment-generation system 102 provides the node link window 802 that says “Partition Variable: Geocity” to indicate the dimension over which the root node element 704 was partitioned to put users into the first child node element 706.

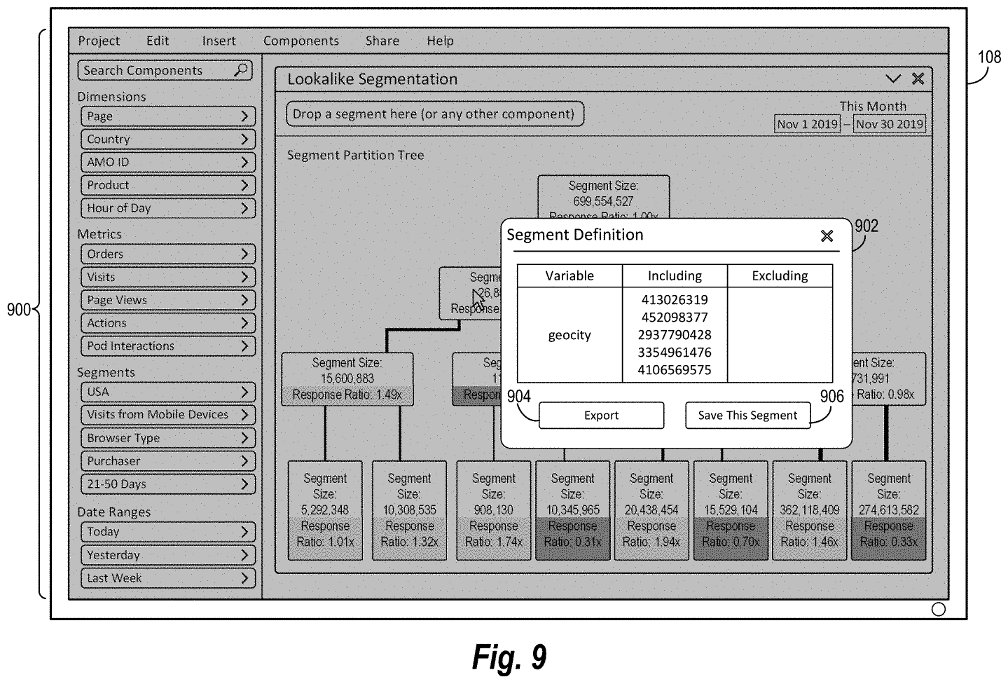

As mentioned, the lookalike-segment-generation system 102 can provide a node tree interface to display node information based on receiving an indication of a selection of a particular node. In particular, the lookalike-segment-generation system 102 can display node information in the form of a segment definition that indicates one or more dimensions associated with the segment or node. Such node information may also include options to export, share, and/or save the corresponding segment or node. FIG. 9 illustrates the client device 108 presenting a node tree interface 900 depicting a node window 902 in accordance with one or more embodiments.

As shown in FIG. 9, the lookalike-segment-generation system 102 receives an indication of a user selection of the first child node element 706. In response, the lookalike-segment-generation system 102 generates and provides the node window 902 for display on the client device 108, where the node window 902 includes a segment definition for the segment of users included within the first child node element 706. For example, the node window 902 includes an indication of the dimension (i.e., the “Variable”) over which the root node was partitioned to generate the first child node element 706. In addition, the node window 902 includes an indication of dimension values of the dimension (“geocity”) that are associated with the first child node element 706 and those that are excluded from the dimension. In some embodiments, the node window 902 can include indications of user identifications for users within the first child node element 706.

As further shown in FIG. 9, the lookalike-segment-generation system 102 generates segments that are immediately actionable within the node tree interface 900. For instance, the lookalike-segment-generation system 102 provides an export option 904 within the node window 902. In response to receiving an indication or a selection of the export option 904, the lookalike-segment-generation system 102 can export the first child node element 706 to one or more other programs. For example, the lookalike-segment-generation system 102 can enable a user to share the node with another user. In addition, the lookalike-segment-generation system 102 provides a save option 906. In response to receiving an indication or a selection of the save option 906, the lookalike-segment-generation system 102 can save the node for later use or recall.

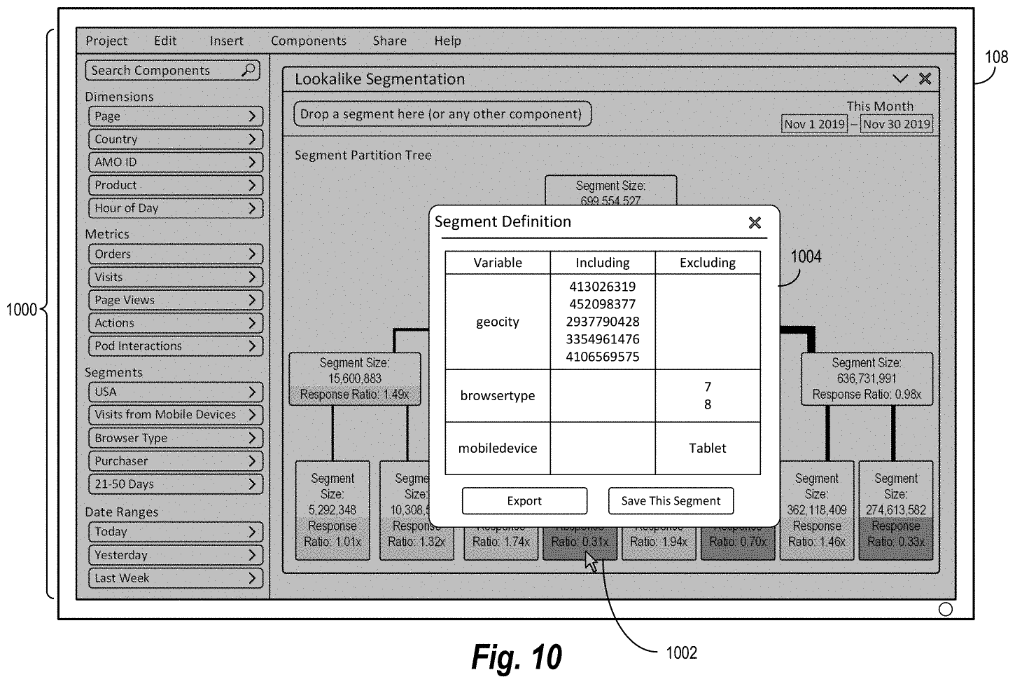

FIG. 10 illustrates the client device 108 presenting a node tree interface 1000 comprising another node window in accordance with one or more embodiments. Based on receiving an indication or selection of the node element 1002 within the node tree interface 1000, the lookalike-segment-generation system 102 provides a node window 1004 for display on the client device 108. As shown in FIG. 10, the node window 1004 includes indications of the dimensions associated with the node element 1002. Indeed, to generate the node element 1002, the lookalike-segment-generation system 102 performs three partitions, each associated with a different dimension. Thus, the node element 1002 is associated with three dimensions: “geocity,” “browsertype,” and “mobiledevice.” The node element 1002 is further associated particular values of the different dimensions. For example, the node window 1004 indicates that the node element 1002 excludes the values 7 and 8 from the “browsertype” dimension and further excludes the dimension value “Tablet” from the “mobiledevice” dimension. Indeed, the lookalike-segment-generation system 102 can generate and provide node windows for each node within a node tree (e.g., the node tree 702) to indicate dimensions and dimension values associated with the nodes.

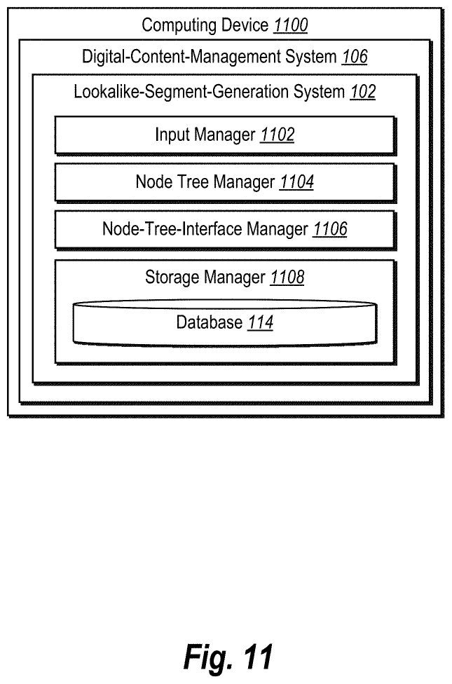

Looking now to FIG. 11, additional detail will be provided regarding components and capabilities of the lookalike-segment-generation system 102. Specifically, FIG. 11 illustrates an example schematic diagram of the lookalike-segment-generation system 102 on an example computing device 1100 (e.g., one or more of the client device 108 and/or the server(s) 104). As shown in FIG. 11, the lookalike-segment-generation system 102 may include an input manager 1102, a node tree manager 1104, a node-tree-interface manager 1106, and a storage manager 1108. The storage manager 1108 can include one or more memory devices that store various data within a columnar database, such as user data corresponding to one or more dimensions for a set of users.

As just mentioned, the lookalike-segment-generation system 102 includes an input manager 1102. In particular, the input manager 1102 manages, receives, provides, detects, determines, recognizes, logs, or otherwise identifies input from a client device (e.g., the client device 108). For example, the input manager 1102 communicates with the client device 108 to receive an indication of user input or interaction with one or more elements within a node tree interface. The input manager 1102 can receive an indication of a selection of a node element and can communicate with the node-tree-interface manager 1106 to cause a display of a node window as a result of the user interaction. The input manager 1102 can further receive indications of selections of target segments, dimensions, time intervals, and other parameters associated with the lookalike-segment-generation system 102.

As also mentioned, the lookalike-segment-generation system 102 includes the node tree manager 1104. In particular, the node tree manager 1104 manages, maintains, stores, accesses, generates, creates, determines, partitions, or otherwise identifies nodes representing segments of users within a node tree. For example, the node tree manager 1104 communicates with the input manager 1102 to receive an indication that a user has opted to build a node tree for a particular set of users based on a particular target segment and in accordance with one or more selected dimensions. The node tree manager 1104 therefore communicates with the storage manager 1108 to access user data from the columnar database 114 to generate a root node for the set of users, partition the root node into two child nodes based on the dimensions and the target segment, and continues recursively partitioning nodes until one or more stop criteria are met.

As illustrated, the lookalike-segment-generation system 102 further includes the node-tree-interface manager 1106. In particular, the node-tree-interface manager 1106 manages, maintains, provides, displays, presents, depicts, portrays, or otherwise generates a node tree interface. For example, the node-tree-interface manager 1106 communicates with the node tree manager 1104 to generate a node tree interface that depicts a generated node tree with various node elements corresponding to the nodes of the node tree. The node-tree-interface manager 1106 further provides for display other elements such as node windows, node links, heat map highlighting, and node link windows based on various user input indicated by the input manager 1102.

In one or more embodiments, each of the components of the lookalike-segment-generation system 102 are in communication with one another using any suitable communication technologies. Additionally, the components of the lookalike-segment-generation system 102 can be in communication with one or more other devices including one or more client devices described above. It will be recognized that although the components of the lookalike-segment-generation system 102 are shown to be separate in FIG. 11, any of the subcomponents may be combined into fewer components, such as into a single component, or divided into more components as may serve a particular implementation. Furthermore, although the components of FIG. 11 are described in connection with the lookalike-segment-generation system 102, at least some of the components for performing operations in conjunction with the lookalike-segment-generation system 102 described herein may be implemented on other devices within the environment.

The components of the lookalike-segment-generation system 102 can include software, hardware, or both. For example, the components of the lookalike-segment-generation system 102 can include one or more instructions stored on a computer-readable storage medium and executable by processors of one or more computing devices (e.g., the computing device 1100). When executed by the one or more processors, the computer-executable instructions of the lookalike-segment-generation system 102 can cause the computing device 1100 to perform the methods described herein. Alternatively, the components of the lookalike-segment-generation system 102 can comprise hardware, such as a special purpose processing device to perform a certain function or group of functions. Additionally or alternatively, the components of the lookalike-segment-generation system 102 can include a combination of computer-executable instructions and hardware.

Furthermore, the components of the lookalike-segment-generation system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the lookalike-segment-generation system 102 may be implemented as part of a stand-alone application on a personal computing device or a mobile device. Alternatively or additionally, the components of the lookalike-segment-generation system 102 may be implemented in any application that allows creation and delivery of marketing content to users, including, but not limited to, applications in ADOBE EXPERIENCE CLOUD, ADOBE ANALYTICS CLOUD, and ADOBE MARKETING CLOUD, such as ADOBE AXLE, ADOBE ANALYTICS, and ADOBE TARGET. “ADOBE,” “ADOBE EXPERIENCE CLOUD,” “ADOBE ANALYTICS CLOUD,” “ADOBE MARKETING CLOUD,” “ADOBE AXLE,” “ADOBE ANALYTICS,” and “ADOBE TARGET” are trademarks of Adobe Inc. in the United States and/or other countries.

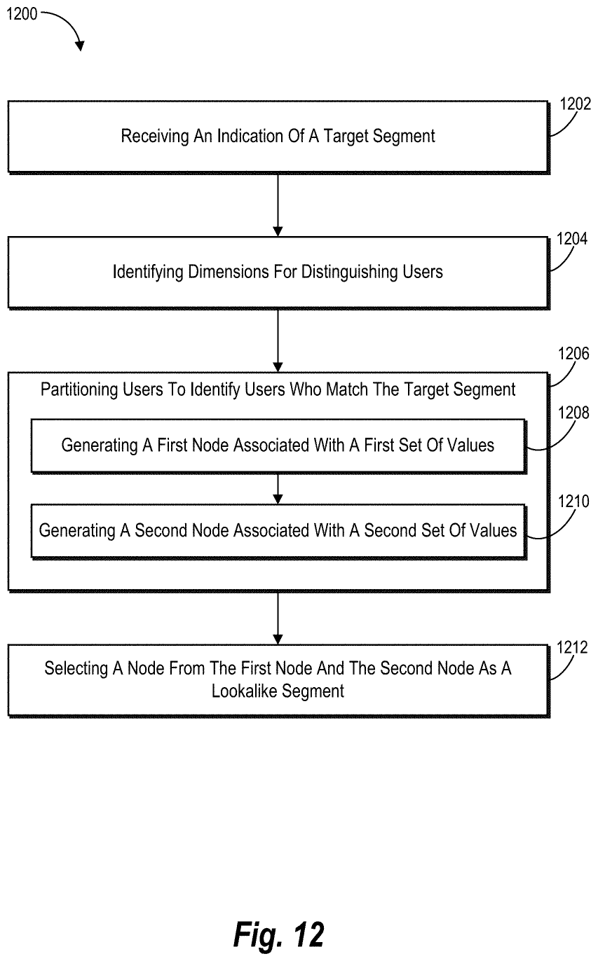

FIGS. 1-11, the corresponding text, and the examples provide a number of different systems, methods, and non-transitory computer readable media for generating and providing lookalike segments by partitioning nodes of a node tree based on dimensions and dimension values. In addition to the foregoing, embodiments can also be described in terms of flowcharts comprising acts for accomplishing a particular result. For example, FIG. 12 illustrates a flowchart of an example sequence or series of acts in accordance with one or more embodiments.

While FIG. 12 illustrates acts according to one embodiment, alternative embodiments may omit, add to, reorder, and/or modify any of the acts shown in FIG. 12. The acts of FIG. 12 can be performed as part of a method. Alternatively, a non-transitory computer readable medium can comprise instructions, that when executed by one or more processors, cause a computing device to perform the acts of FIG. 12. In still further embodiments, a system can perform the acts of FIG. 12. Additionally, the acts described herein may be repeated or performed in parallel with one another or in parallel with different instances of the same or other similar acts.

FIG. 12 illustrates an example series of acts 1200 for generating and providing a node tree interface that indicates lookalike segments by partitioning nodes of a node tree based on target segments, dimensions, and dimension values. The series of acts 1200 includes an act 1202 of receiving an indication of a target segment. In particular, the act 1202 can involve receiving, from a client device, an indication of a target segment representing users within a set of users.

As shown, the series of acts 1200 includes an act 1204 of identifying dimensions for distinguishing users. In particular, the act 1204 can involve identifying one or more dimensions for distinguishing the set of users. For example, the act 1204 can involve accessing a columnar database comprising rows that correspond to respective users within the set of users and columns that correspond to respective dimensions of a plurality of dimensions. In some embodiments, the act 1204 can involve determining a dimension for partitioning the set of users by comparing candidate nodes comprising subsets of users portioned according to one or more dimensions.

Additionally, the series of acts 1200 includes an act 1206 of partitioning users to identify users who match the target segment. In particular, the act 1206 can involve partitioning the set of users to identify users who match the target segment based on a dimension from the one or more dimensions by performing additional acts such as acts 1208 and 1210. In some embodiments, the act 1206 can involve partitioning the set of users into a first node including a subset of users associated with a first set of values for the dimension and a second node including a subset of users associated with a second set of values for the dimension by determining a first probability of the subset of users from the first node matching the target segment and a second probability of the subset of users from the second node matching the target segment and determining that the first node and the second node satisfy a threshold gain in entropy relative to the set of users based on the first probability and the second probability.

Indeed, the act 1206 can further involve an act 1208 of generating a first node associated with a first set of values. In particular, the act 1208 can involve generating a first node comprising a subset of users from the set of users that are associated with a first set of values for the dimension and that correspond to a first probability of matching the target segment.

In addition, the at 1206 can involve an act 1210 of generating a second node associated with a second set of values. In particular, the act 1208 can involve generating a second node comprising a subset of users from the set of users that are associated with a second set of values for the dimension and that correspond to a second probability of matching the target segment. Generating the first node and the second node can include identifying subsets of users corresponding to different dimensions from the one or more dimensions and different values for the different dimensions, comparing candidate nodes comprising the subsets of users based on probabilities of the subsets of users matching the target segment, and based on the comparison, selecting the first node and the second node from the candidate nodes by determining that the first node and second node satisfy a threshold gain in entropy with respect to the set of users. Comparing the candidate nodes can include arranging values of a given dimension from the one or more dimensions in order of increasing probabilities of the subsets of users who correspond to the values matching the target segment.

Further, the series of acts 1200 can include an act 1212 of selecting a node from the first node and the second node as a lookalike segment. In particular, the act 1212 can involve providing, for display within a node tree interface of the client device, interactive node elements for the first node and the second node within the node tree and an indicator of the first node or the second node as the lookalike segment. The act 1212 can involve selecting, for display within a node tree interface of the client device, the first node as a lookalike segment for the target segment based on the first probability of matching the target segment. In some embodiments, the act 1212 can involve selecting the first node as the lookalike segment to the target segment by determining that the first probability of matching the target segment satisfies a threshold probability of matching the target segment and the first node shares at least one value associated with the one or more dimensions with the set of users.

In some embodiments, the series of acts 1200 can involve an act of providing, for display within the node tree interface, a root node element representing the set of users, a first node element representing the first node, and a second node element representing the second node. For example, the acts 1200 can involve an act of providing, for display within the node tree interface, a root node element representing the set of users and branching from the root node element to a first node element representing the first node and to a second node element representing the second node. The node tree interface can include a visual representation indicating a difference between a first number of users from the set of users partitioned into the first node and a second number of users from the set of users partitioned into the second node.

The series of acts 1200 can include an act of providing, for display within the first node element and the second node element, visual indicators representing respective probabilities of users within the first node and the second node matching the target segment. For example, the visual indicators can include a first color for the first node element that indicates the first probability of matching the target segment and a second color for the second node that indicates the second probability of matching the target segment. The series of acts 1200 can also include an act of providing, for display within the node tree interface: a first node link connecting the root node element to the first node element and including a first thickness corresponding to a number of the subset of users within the first node and a second node link connecting the root node element to the second node element and including a second thickness corresponding to a number of the subset of users within the second node.

In one or more embodiments, the series of acts 1200 can include an act of determining that the first node satisfies a threshold probability of matching the target segment and shares at least one value associated with the one or more dimensions with the set of users. The series of acts 1200 can also (or alternatively) include acts of receiving, from the client device, an indication of a selection of an interactive node element corresponding to the first node and in response to the selection, providing a node window indicating dimensions and dimension values associated with the first node.

The series of acts 1200 can include an act of generating a node tree that includes a plurality of nodes including the first node and the second node by recursively partitioning one or more nodes of the plurality of nodes into additional nodes (based on probabilities of users within the plurality of nodes matching the target segment) and stopping the recursive partitioning based on one or more of determining that the node tree satisfies a threshold depth or determining that a node within the node tree includes fewer than a threshold number of users. Recursively partitioning the one or more nodes can involve weighting probabilities that a given subset of users of a given node match the target segment based on a number of the given subset of users and a number of users within the set of users.

In some embodiments, the series of acts 1200 includes an act of receiving an indication of a selection of the first node element from the client device and an act of, in response to the selection, provide a node window depicting dimensions associated with the first node and/or dimension values associated with the first node.

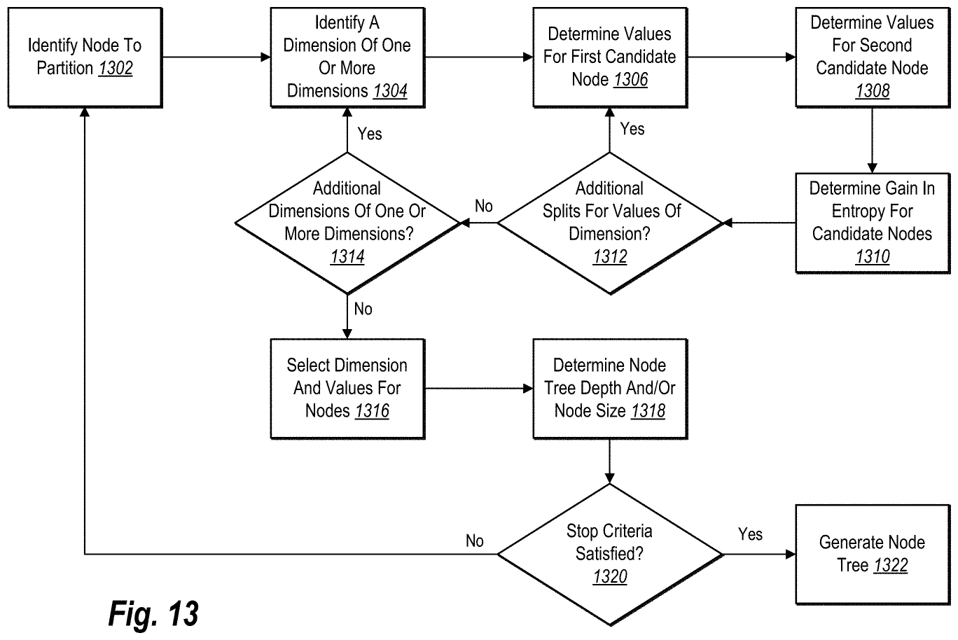

In some embodiments, the lookalike-segment-generation system 102 can perform a step for generating a node tree comprising a first node of a subset of users and a second node of a subset of users partitioned from the set of users based on one or more dimensions. As possible support and/or structure, FIG. 13 illustrates an algorithm that the lookalike-segment-generation system 102 performs as part of a step for generating a node tree comprising a first node of a subset of users and a second node of a subset of users partitioned from the set of users based on one or more dimensions.

As illustrated, the lookalike-segment-generation system 102 performs an act 1302 to identify a node to partition. In particular, the lookalike-segment-generation system 102 identifies a root node including an initial set of users or some other node including a subset of users. In addition, the lookalike-segment-generation system 102 performs an act 1304 to identify a dimension of one or more dimensions over which to partition the identified node. For example, the lookalike-segment-generation system 102 identifies a dimension over which to partition the node by comparing candidate nodes that result from possible partitions of the node, as described above.

As illustrated in FIG. 13, the lookalike-segment-generation system 102 also performs an act 1306 to determine values for a first candidate node. In particular, the lookalike-segment-generation system 102 determines dimension values within the identified dimension to assign to a first candidate node. In addition, the lookalike-segment-generation system 102 performs an act 1308 to determine values for a second candidate node. To determine the dimension values for the first candidate node and the second candidate node, as described above, the lookalike-segment-generation system 102 selects dimension values to test for partitioning based on the probabilities of the nodes matching a target segment.

Indeed, the lookalike-segment-generation system 102 performs an act 1310 to determine a gain in entropy for the candidate nodes. In particular, the lookalike-segment-generation system 102 determines a gain in entropy for each of the candidate nodes based on the currently selected dimension and dimension values.

Additionally, the lookalike-segment-generation system 102 performs an act 1312 to determine whether there are additional splits for values of the dimension. In particular, the lookalike-segment-generation system 102 determines whether there are different dimension values of the identified dimension that could be assigned to various candidate nodes. Based on determining that there are additional different splits of dimension values, the lookalike-segment-generation system 102 repeats the acts 1306-1312 until there are no more different ways to divide the dimension values between candidate nodes.

As shown in FIG. 13, based on determining that there are no more additional splits for the dimension values for the current dimension, the lookalike-segment-generation system 102 performs an act 1314 to determine whether there are additional dimensions of the one or more dimensions over which the node could be partitioned. For example, the lookalike-segment-generation system 102 determines whether there are additional dimensions indicated by a user that have not yet been analyzed for partitioning into candidate nodes.

Based on determining that there are additional dimensions to analyze, the lookalike-segment-generation system 102 repeats the acts 1304-1314 to identify an additional dimension, determine values for candidate nodes, and determine a gain in entropy for each of the dimension-dimension value combinations. Based on determining that there are no more dimensions, on the other hand, the lookalike-segment-generation system 102 performs an act 1316 to select a dimension and dimension values for child nodes. In particular, the lookalike-segment-generation system 102 determines the dimension over which to partition the identified node and selects those candidate nodes that have dimension values within the dimension that satisfy the threshold gain in entropy.

As further shown in FIG. 13, the lookalike-segment-generation system 102 further performs an act 1318 to determine a node tree depth and/or a node size. In particular, the lookalike-segment-generation system 102 determines a depth of the node tree by determining how many layers are within the node tree and/or how many partitions have been performed within the node tree. The lookalike-segment-generation system 102 determines a size of a child node by determining a number of users within the child node.

Based on these determinations, the lookalike-segment-generation system 102 further performs an act 1320 to determine whether the stop criteria are satisfied. In particular, the lookalike-segment-generation system 102 determines whether the node tree satisfies a threshold depth and/or whether a node within the node tree has fewer than a threshold number of users. Based on determining that the stop criteria are not yet satisfied, the lookalike-segment-generation system 102 continues partitioning nodes to grow the node tree by repeating the acts 1302-1320 until the stop criteria are satisfied. Based on determining that the stop criteria are satisfied, the lookalike-segment-generation system 102 performs an act 1322 to generate a completed node tree.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 14 illustrates, in block diagram form, an example computing device 1400 (e.g., the computing device 1100, the client device 108, and/or the server(s) 104) that may be configured to perform one or more of the processes described above. One will appreciate that the lookalike-segment-generation system 102 can comprise implementations of the computing device 1400. As shown by FIG. 14, the computing device can comprise a processor 1402, memory 1404, a storage device 1406, an I/O interface 1408, and a communication interface 1410. Furthermore, the computing device 1400 can include an input device such as a touchscreen, mouse, keyboard, etc. In certain embodiments, the computing device 1400 can include fewer or more components than those shown in FIG. 14. Components of computing device 1400 shown in FIG. 14 will now be described in additional detail.

In particular embodiments, processor(s) 1402 includes hardware for executing instructions, such as those making up a computer program. As an example, and not by way of limitation, to execute instructions, processor(s) 1402 may retrieve (or fetch) the instructions from an internal register, an internal cache, memory 1404, or a storage device 1406 and decode and execute them.

The computing device 1400 includes memory 1404, which is coupled to the processor(s) 1402. The memory 1404 may be used for storing data, metadata, and programs for execution by the processor(s). The memory 1404 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 1404 may be internal or distributed memory.

The computing device 1400 includes a storage device 1406 includes storage for storing data or instructions. As an example, and not by way of limitation, storage device 1406 can comprise a non-transitory storage medium described above. The storage device 1406 may include a hard disk drive (“HDD”), flash memory, a Universal Serial Bus (“USB”) drive or a combination of these or other storage devices.

The computing device 1400 also includes one or more input or output (“I/O”) devices/interfaces 1408, which are provided to allow a user to provide input to (such as user strokes), receive output from, and otherwise transfer data to and from the computing device 1400. These I/O devices/interfaces 1408 may include a mouse, keypad or a keyboard, a touch screen, camera, optical scanner, network interface, modem, other known I/O devices or a combination of such I/O devices/interfaces 1408. The touch screen may be activated with a writing device or a finger.

The I/O devices/interfaces 1408 may include one or more devices for presenting output to a user, including, but not limited to, a graphics engine, a display (e.g., a display screen), one or more output drivers (e.g., display drivers), one or more audio speakers, and one or more audio drivers. In certain embodiments, devices/interfaces 1408 is configured to provide graphical data to a display for presentation to a user. The graphical data may be representative of one or more graphical user interfaces and/or any other graphical content as may serve a particular implementation.

The computing device 1400 can further include a communication interface 1410. The communication interface 1410 can include hardware, software, or both. The communication interface 1410 can provide one or more interfaces for communication (such as, for example, packet-based communication) between the computing device and one or more other computing devices 1400 or one or more networks. As an example, and not by way of limitation, communication interface 1410 may include a network interface controller (NIC) or network adapter for communicating with an Ethernet or other wire-based network or a wireless NIC (WNIC) or wireless adapter for communicating with a wireless network, such as a WI-FI. The computing device 1400 can further include a bus 1412. The bus 1412 can comprise hardware, software, or both that couples components of computing device 1400 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method for generating node trees for target segments, the computer-implemented method comprising:
receiving, from a client device, an indication of a target segment representing users within a set of users;
performing a step for generating a node tree comprising a first node of a subset of users and a second node of a subset of users partitioned from the set of users based on one or more dimensions;
selecting the first node or the second node as a lookalike segment for the target segment; and
providing, for display within a node tree interface of the client device, interactive node elements for the first node and the second node within the node tree and an indicator of the first node or the second node as the lookalike segment.

2. The computer-implement method of claim 1, wherein selecting the first node as the lookalike segment comprises determining that the first node satisfies a threshold probability of matching the target segment and shares at least one value associated with the one or more dimensions with the set of users.

3. The computer-implemented method of claim 1, further comprising:
receiving, from the client device, an indication of a selection of an interactive node element corresponding to the first node; and
in response to the selection, providing a node window indicating dimensions and dimension values associated with the first node.

4. The computer-implemented method of claim 1, wherein the node tree interface comprises a visual representation indicating a difference between a first number of users from the set of users partitioned into the first node and a second number of users from the set of users partitioned into the second node.

5. The computer-implemented method of claim 1, further comprising identifying the one or more dimensions for partitioning the set of users by accessing a columnar database comprising rows that correspond to respective users within the set of users and columns that correspond to respective dimensions of a plurality of dimensions.

6. A non-transitory computer readable medium comprising instructions that, when executed by at least one processor, cause a computing device to:
receive, from a client device, an indication of a target segment representing users within a set of users;
identify one or more dimensions for distinguishing the set of users;
partition the set of users to identify users who match the target segment based on a dimension from the one or more dimensions by:
generating a first node comprising a subset of users from the set of users that are associated with a first set of values for the dimension and that correspond to a first probability of matching the target segment; and
generating a second node comprising a subset of users from the set of users that are associated with a second set of values for the dimension and that correspond to a second probability of matching the target segment; and
select, for display within a node tree interface of the client device, the first node as a lookalike segment for the target segment based on the first probability of matching the target segment.

7. The non-transitory computer readable medium of claim 6, further comprising instructions that, when executed by the at least one processor, cause the computing device to generate the first node and the second node by:
identifying subsets of users corresponding to different dimensions from the one or more dimensions and different values for the different dimensions;
comparing candidate nodes comprising the subsets of users based on probabilities of the subsets of users matching the target segment; and
based on the comparison, selecting the first node and the second node from the candidate nodes by determining that the first node and second node satisfy a threshold gain in entropy with respect to the set of users.

8. The non-transitory computer readable medium of claim 7, wherein comparing the candidate nodes comprises arranging values of a given dimension from the one or more dimensions in order of increasing probabilities of the subsets of users who correspond to the values matching the target segment.

9. The non-transitory computer readable medium of claim 6, further comprising instructions that, when executed by the at least one processor, cause the computing device to generate a node tree comprising a plurality of nodes including the first node and the second node by:
recursively partitioning one or more nodes of the plurality of nodes into additional nodes; and
stopping the recursive partitioning based on one or more of determining that the node tree satisfies a threshold depth or determining that a node within the node tree includes fewer than a threshold number of users.

10. The non-transitory computer readable medium of claim 9, further comprising instructions that, when executed by the at least one processor, cause the computing device to select the first node as the lookalike segment to the target segment by determining that the first probability of matching the target segment satisfies a threshold probability of matching the target segment and the first node shares at least one value associated with the one or more dimensions with the set of users.

11. The non-transitory computer readable medium of claim 6, further comprising instructions that, when executed by the at least one processor, cause the computing device to provide, for display within the node tree interface, a root node element representing the set of users, a first node element representing the first node, and a second node element representing the second node.

12. The non-transitory computer readable medium of claim 11, further comprising instructions that, when executed by the at least one processor, cause the computing device to:
receive an indication of a selection of the first node element from the client device; and
in response to the selection, provide a node window depicting dimensions associated with the first node.

13. The non-transitory computer readable medium of claim 11, further comprising instructions that, when executed by the at least one processor, cause the computing device to provide, for display within the first node element and the second node element, visual indicators representing respective probabilities of users within the first node and the second node matching the target segment.

14. A system comprising:
one or more memory devices comprising a columnar database of user data for a set of users; and
one or more server devices that are configured to cause the system to:
receive, from a client device, an indication of a target segment representing users within the set of users;
determine a dimension for partitioning the set of users by comparing candidate nodes comprising subsets of users portioned according to one or more dimensions;
partition the set of users into a first node comprising a subset of users associated with a first set of values for the dimension and a second node comprising a subset of users associated with a second set of values for the dimension by:
determining a first probability of the subset of users from the first node matching the target segment and a second probability of the subset of users from the second node matching the target segment; and
determining that the first node and the second node satisfy a threshold gain in entropy relative to the set of users based on the first probability and the second probability; and
select, for display within a node tree interface of the client device, the first node as a lookalike segment for the target segment based on the first probability of the subset of users from the first node matching the target segment satisfying a threshold probability.

15. The system of claim 14, wherein the one or more server devices are further configured to cause the system to generate a node tree comprising a plurality of nodes including the first node and the second node by recursively partitioning the plurality of nodes based on probabilities of users within the plurality of nodes matching the target segment.

16. The system of claim 15, wherein the one or more server devices are further configured to cause the system to stop the recursive partitioning based on one or more of determining that the node tree satisfies a threshold depth or determining that a node of the plurality of nodes includes fewer than a threshold number of users.

17. The system of claim 16, wherein the one or more server devices are further configured to cause the system to partition the set of users into the first node and the second node based on weighting probabilities that users of the first node match the target segment based on a number of users within the first node and a number of users within the set of users.

18. The system of claim 14, wherein the one or more server devices are further configured to cause the system to provide, for display within the node tree interface, a root node element representing the set of users and branching from the root node element to a first node element representing the first node and to a second node element representing the second node.

19. The system of claim 18, wherein the one or more server devices are further configured to:
receive a selection of the first node element from the client device; and
in response to the selection, provide a node window indicating dimension values associated the first node.

20. The system of claim 18, wherein the one or more server devices are further configured to provide, for display within the first node element and the second node element, visual indicators comprising:
a first color for the first node element that indicates the first probability of matching the target segment; and
a second color for the second node that indicates the second probability of matching the target segment.
